(19) United States
(12) Patent Application Publication
(10) Pub. No.: US 2004/0194106 A1
(43) Pub. Date: Sep. 30, 2004

(54) Name/address translation device

(75) Inventor: Jun Ogawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/780,598

(22) Filed: Feb. 19, 2004

(30) Foreign Application Priority Data
Mar. 28, 2003 (JP) 2003-91293

(51) Int. Cl. G06F 9/46

(52) U.S. Cl. 718/100

(57) ABSTRACT

A name/address translation device includes judging unit for judging, when receiving a query, transmitted from a communication source, about an address corresponding to a name of a communication destination, whether a communication between the communication source and a communication destination is permitted or not, on the basis of network types to which the communication source and the communication destination respectively belong, second judging unit for judging based on a result of the judgment by the judging unit whether or not a communication destination address corresponding to the name is given as a response to the communication source, and response unit for acquiring, when the second judging unit judges that the address of the communication destination is given as the response, the address of the communication destination and giving the address of the communication destination as the response to the communication source.

### BACKGROUND OF THE INVENTION

The invention relates to a negotiation when establishing communications between IP networks.

The following are conventional technologies related to IP (Internet Protocol) communications.

(1) Name Resolution

When performing the IP communications, a user of a communication source (querying source) terminal generally designates a communication destination (query destination) with a host name. DNS (Domain Name System) is utilized for translating this host name into an IP address. The DNS is, in a TCP/IP network environment, a service for enabling a corresponding IP address to be acquired from the host name (a domain name) of the communication destination (the querying source), i.e., a system for providing the [Name Resolution]. A DNS server manages a database that describes a corresponding relationship between the host name and the IP address, and functions so that the IP address can be referred to in response to a request from a client on the basis of the host name. The user is thereby able to access a network by designating not a hard-to-memorize and hard-to-understand IP address but a host name. A substance of the DNS is a distributed database, wherein resolutions of a tremendous number of names and IP addresses are actualized based on a structure called a domain tree as shown in FIG. 1.

As shown in FIG. 1, in the domain tree, the DNS server located at each node basically knows only information within a domain administered by the DNS server itself and DNS servers of sub-domains. Therefore, a querying side to the DNS can eventually trace this hierarchy sequentially from the high-order down to the DNS server that knows an IP address (“www.forum.atmark.co.jp” in FIG. 1) on the basis of the host name. The name resolution is actualized by the technique described above in the IP communications.

(2) Type of IP Address and Address Translation Technology

In the IP address, two types of address spaces of a “global IP address” and a “private IP address” are defined based on an assignment policy thereof. The global IP address is an IP address allowed to be used in the Internet. The private IP address (defined in RFC1918) is an IP address that can be utilized without any restriction as a network address within an organization having no necessity of always connecting to the outside (Internet).

In the communications extending over the private IP address space and the global IP address space wherein these two types of IP addresses are defined respectively, an address translation technique called a NAT (Network Address Translation) is needed at a boundary between the two spaces. The NAT mutually translates the private IP address usable only within an office and the essential global IP address utilizable for accessing the Internet (outside). Even a node assigned only a local IP address is thereby capable of transparently accessing the Internet.

A technology related to the IP address translation described above is disclosed in, e.g., Patent document 1.

(3) Communications Extending over Private IP

Address Space and Global IP Address Space

Given next is an explanation of one example of the communications extending over the private IP address space and the global IP address space. FIGS. 2A and 2B are a processing sequence illustrated by way of an example of performing the communication with the global IP address network from the private IP address network by use of a proxy server and its notation respectively.

The proxy server is a software device disposed, as shown in FIG. 2A, between an intra-office (enterprise A) network and the outside (the Internet) for monitoring an inflow and an outflow of data. The proxy server, for monitoring the data inflow/outflow, functions as a routing device on the application layer, which functions so as to terminate the data flow from an interior at an application layer level and to forward the data after being elaborately examined towards the outside.

In the communications extending over the private IP address space and the global IP address space, the installation of the proxy server has the following three purposes.

(1) Owing to the installation of the proxy server, the proxy server detects a host name of a communication destination (a querying destination) existing within application data, and judges whether it is proper to the communication from within the office or not. When judging that it is an improper communication, this is not routed.

Namely, all the communications extending over the private IP address network and the global IP address network require terminating on the application layer, and only a specified application (which is generally HTTP) can be routed through the application layer on the proxy server (Proxy.flab.fujitsu.com as named in FIG. 2A) on DMZ (DeMilitarized Zone). Further, the proxy server generally can determine a validity of the communication from a name (which is FQDN (Fully Qualified Domain Name: A.outisde.com named in FIG. 2A) in URL (Uniform Resource Locator) in the case of HTTP) of the querying destination (the communication destination)).

(2) A packet existing within the private IP address network in which the global IP address is set as a source address (SRC address) or a destination address (DST address), is not allowed to flow.

Namely, in the communications extending over the private IP address network and the global IP address network, route control to the global IP address network is needed in the private IP network, and hence the route control within the private IP network becomes intricate. The provision of the proxy server, however, in the name resolution, makes the route information of the global IP address successfully prohibit flowing into the private address network by preventing an acquisition of an address in the global IP address from within the private IP address network.

(3) Communications from a terminal on the global IP address network to the private IP address network are inhibited.

An inhibition of the communications from the terminal on the global IP address network to the private IP address network, is generally known as a should-pay-attention point when performing the communications between the private IP address network and the global IP address network.

In the DNS domain tree architecture, the name resolution of the terminal residing in the private IP address network has not hitherto been carried out from on the global IP address network, or the communication to the private IP address network from the terminal on the global IP address network has hitherto been inhibited by discarding a packet with its querying source (a communication source) being the terminal residing on the global IP address network by use of an address translation device existing on the DMZ, and so on.

For others, as the technology pertaining to the IP address translation, there is a technology disclosed in Patent document 2.

[Patent document 1]

Japanese Patent Application Laid-Open Publication No.2000-156710

[Patent document 2]

Japanese Patent Application Laid-Open Publication No.2001-156852

In the communication system extending over the address spaces existing at the present as described above has the following problems.

(1) Load on Proxy Server

A proxy server always, as a representative, needs to perform an application relay during a flowing period of each data flow extending an interior and an exterior of a private IP network, and therefore has a heavy load.

(2) Limit of Application

The proxy server performs the application relay, and hence, when the application is out of a support object (e.g., IP telephony) of the communications extending to the interior and the exterior of the private IP network, the applications that can be relayed by the proxy server are limited. Further, when wishing to make impermissible the communication to the outside of the private IP network with respect to a specified application, a network administrator, etc. operates the proxy server, whereby the application can be intentionally limited.

### SUMMARY OF THE INVENTION

The invention solves the above problems and aims at providing a device and a method capable of actualizing communications extending over the private IP address space and the global IP address space through a linkage between a DNS server residing on a boundary between the private IP address network and the global IP address network and the address translation device without using the proxy server (by attaining a function and a role that have hitherto been taken by the proxy server).

To solve the problems, the invention takes the following architectures. Namely, a first mode of the invention is a name/address translation device comprising judging means for judging, when receiving a query, transmitted from a communication source, about an address corresponding to a name of a communication destination, whether a communication between the communication source and a communication destination is permitted or not, on the basis of network types to which the communication source and the communication destination respectively belong, second judging means for judging based on a result of the judgment by the judging means whether or not a communication destination address corresponding to the name is given as a response to the communication source, and response means for acquiring, when the second judging means judges that the address of the communication destination is given as the response, an address of the communication destination and giving it as the response to the communication source.

According to the first mode of the invention, in the name/address translation device, when receiving the query of the address corresponding to the name of the communication destination from the communication source, the judging means judges, based on the network types to which the communication source and the communication destination respectively belong, whether the communication between the communication source and the communication destination is permitted or not. Based on the result of this judgment, the second judging means judges whether or not the communication destination address corresponding to the name contained in the query is given as the response to the communication source. When judging that the communication destination address is given as the response, the response means acquires the communication destination address and gives it as the response to the communication source. Thus, according to the first mode, it can be judged based on conditions of both of the communication source and the communication destination whether or not the address corresponding to the name is given as the response.

Further, a second mode of the invention is name/address translation device comprising receiving means for receiving a query about a communication destination address corresponding to a communication destination name, the query being transmitted from a first network and a second network, identifying means for identifying the networks to which a communication source having transmitted the query and the communication destination respectively belong, searching means for searching for an address of the communication destination to be given to the communication source as a response when the communication source belongs to the first network and when the communication destination belongs to the second network, and sending means for sending the response containing the address of the communication destination, wherein the sending means, when the communication source belongs to the second network and when the communication destination belongs to the first network, does not send the response containing the address of the communication destination.

According to the second mode of the invention, in the name/address translation device, when transmitting the query about the communication destination address corresponding to the name of the communication destination to the second network from the first network, the receiving means receives the query. The identifying means identifies, from the received query, the networks to which the communication source and the communication destination respectively belong. The searching means searches for an address of the communication destination of which a response is given to the communication source of the query when the communication source belongs to the first network and when the communication destination belongs to the second network. The sending means sends the response containing the communication destination address. Further, the sending means, when the communication source belongs to the second network and when the communication destination belongs to the first network, does not send the response containing the address of the communication destination. Thus, according to the second mode, the network types under which the communication source and the communication destination come, are identified, and it can be judged whether the communication destination address is given as the response or not, corresponding to the network types. Namely, it can be schemed so that the name resolution can be conducted from the first network towards the second network, whereas the name resolution cannot be conducted from the second network towards the first network, whereby the security of the first network can be enhanced. For example, the private IP address network can be applied to the first network, and the global IP address network can be applied to the second network.

Preferably, the sending means in the second mode, when there is no application of which a use is permitted in a communication between the communication source belonging to the first network and the communication destination belonging to the second network, can be constructed so as not to give the response of the communication destination address to the communication source.

In this case, the sending means, when there is no application of which the use is permitted in the communication between the communication source and the communication destination, does not give the communication destination address as the response to the communication source. This makes it possible to prevent the communication using the application of which the use is not permitted between the first network and the second network.

Preferably, the name/address translation device according to the second mode may further comprise notifying means for notifying a routing device of passage information for letting data pass through that are forwarded between a first terminal and a second terminal, the routing device receiving, when a response of an address of the second terminal corresponding to the communication destination belonging to the second network is given to the first terminal corresponding to the communication source belonging to the first network, pieces of data forwarded between the first network and the second network and letting only the data with its passage permitted pass through, and effecting an address translation between the first network and the second network.

In this instance, when the address of the second terminal is given as the response from the name/address translation device, the notifying means notifies the routing device of the passage information for letting the data forwarded between the first terminal and the second terminal pass through. This enables the routing device to be controlled so as to make transmissible the data between the terminals with the name resolutions performed by the name/address translation device with respect to the data forwarded between the first network and the second network, and enables the data with its passage unpermitted to be eliminated (cut off) in the routing device.

Preferably, the notifying means in the second mode can be constructed so as to notify, when the routing device lets the data transmitted from the second terminal pass through, the routing device of passage information containing an address of the first network that is virtually assigned to the second terminal and an on-the-second-network address of the second terminal in order to translate the on-the-second-network address of the second terminal that is added as a source address to this piece of data into an on-the-first network address, and the sending means can be constructed so as to send, when the first terminal adds the on-the-first-network address of the second terminal to the data addressed to the second terminal and thus transmits it and when the routing device lets the data addressed to the second terminal pass through, a response containing the one-the-first-network address of the second terminal in order to translate the destination address added to this piece of data into the on-the-second-network address of the second terminal.

In this case, the notifying means notifies the routing device of the on-the-first network address virtually assigned to the second terminal and the on the-second-network address. The sending means, in response to the query from the first terminal, sends the response containing the on-the-first-network address of the second terminal. This makes it feasible to prevent the on the-second-network addresses from an inflow into the first network and enables the first terminal to recognize the second terminal as a terminal within the first network. Accordingly, it is feasible to actualize the communications over the different two address spaces without performing the route control for the second network in the first network by use of the address usable in the first network that is virtually assigned to the terminal in the second network, and to assure independence of the routes in the first network and the second network.

Preferably, the notifying means in the second mode can be constructed so as to notify the routing device of the passage information further containing information about an application of which the utilization is permitted in the communication between the first terminal and the second terminal in order for the routing device to let only the data pass through which is based on the application of which the utilization is permitted between the first terminal and the second terminal.

In such a case, the routing device transmits only the data related to the application with its utilization permitted pass through in the communication between the first terminal and the second terminal. This makes it feasible to prevent the communication using the application with its utilization unpermitted between the first terminal and the second terminal.

Preferably, the notifying means in the second mode can be constructed so as to notify, before the sending means sends the address of the second terminal, the routing device of the passage information.

In this case, before the response containing the address of the second terminal arrives, the routing device can be constructed so as to be already registered with the passage information (filtering information) for letting the data pass through. This enables the name/address translation device to efficiently carry out, without any contradiction, the operation for the communication source to send the data to the communication destination in cooperation with the routing device.

The architectures of the sending means and the notifying means explained in the second mode can be applied to the first mode.

Further, the invention can be specified as a method by which a computer as the name/address translation device executes the operations shown in the first mode and the second mode. Moreover, the invention can be also specified as a program for making the computer function as the name/address translation devices in the first mode and the second mode, or specified as a recording medium recorded with this program.

The invention can be applied to a system in which the name/address translation device cooperates with the routing device in the communications extending over the private IP address space and the global IP address space.

### DESCRIPTION OF THE DRAWINGS

FIG. 1 is a view of a DNS tree showing an architecture of DNS as a prior art.

FIGS. 2A and 2B are views showing a DNS flow in a communication from a private IP address network to a global IP address network in the prior art.

FIGS. 3A and 3B are views showing a communication from the private IP address network to the global IP address network at a communication permitting time in an embodiment of the invention and its notation respectively.

FIG. 4 is a view showing how the global IP address network appears to the private IP address network.

FIG. 5 is a diagram showing a response of a DNS server in accordance with a querying source of a name resolution request.

FIG. 6 is a view showing a system architecture of the DNS server in the embodiment of the invention.

FIG. 7 is a view showing a system architecture of an address translation/filtering device in the embodiment of the invention.

FIG. 8 is a diagram showing a packet data structure in the embodiment of the invention.

FIG. 9 is a flowchart showing an operation of the DNS server in the embodiment of the invention.

FIG. 10 is a flowchart showing an operation of the address translation/filtering device in the embodiment of the invention.

FIGS. 11A and 11B are views showing a process of returning a private IP in the embodiment of the invention and its notation respectively.

FIGS. 12A and 12B are views showing a communication to the global IP address network from the private IP address network at a name-based communication rejecting time in the embodiment of the invention and its notation respectively.

FIG. 13 is a view showing a communication to the global IP address network from the private IP address network at a port-based communication rejecting time in the embodiment of the invention.

FIGS. 14A and 14B are views showing a communication to the private IP address network from the global IP address network in the embodiment of the invention and its notation respectively.

FIGS. 15A and 15B are views showing a communication to the global IP address network from the global IP address network in the embodiment of the invention and its notation respectively.

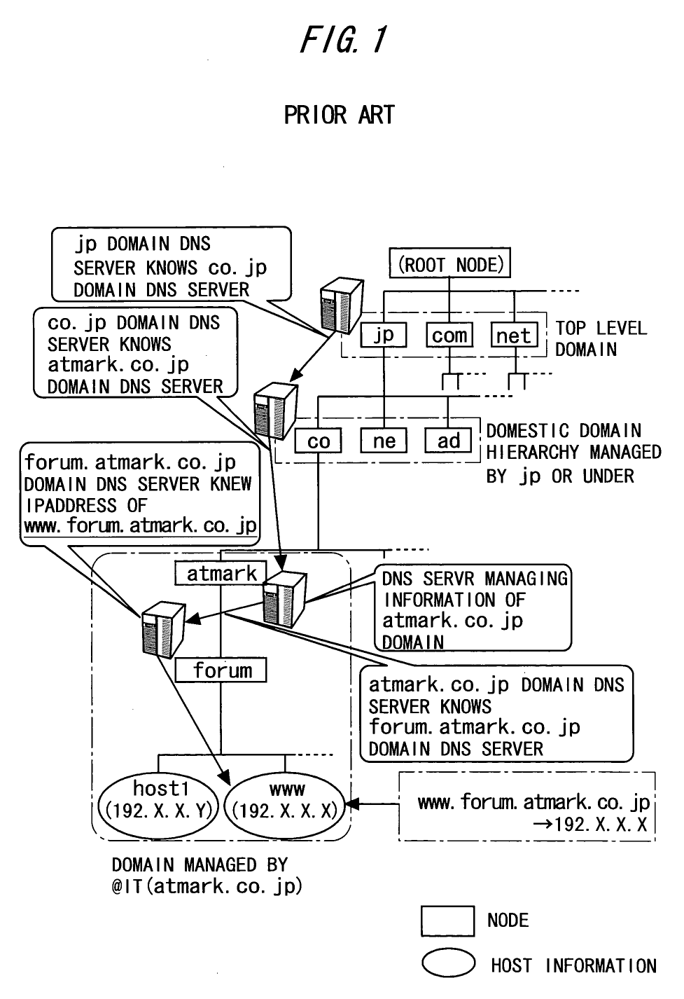

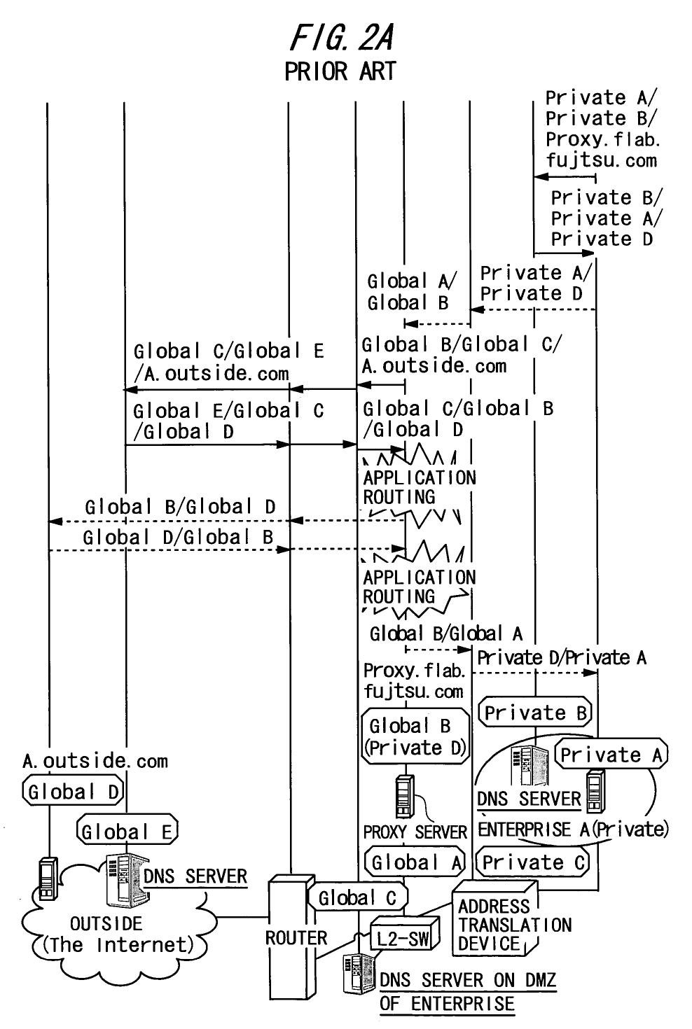

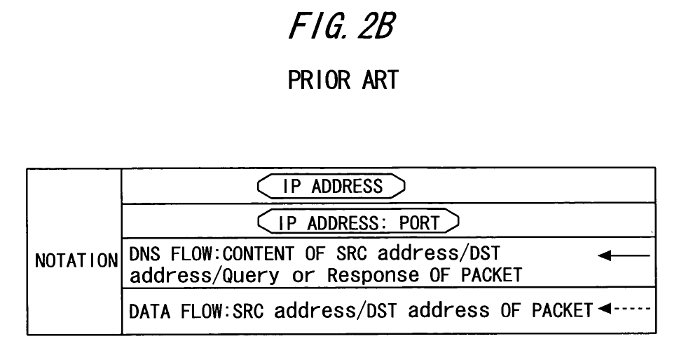

### DETAILED DESCRIPTION OF THE INVENTION

### Embodiments

Embodiments of the invention will hereinafter be described by use of the drawings. Hereafter, in the embodiments, the explanation will be made, wherein a terminal becoming a communication source making a request for a name resolution is termed a querying source, a terminal becoming a communication destination with respect to the request for the name resolution is termed a querying destination, an address indicating the querying source of a packet is termed a source address, and an address indicating the querying destination of the packet is termed a destination address. Note that the explanations of the embodiment are exemplifications, and the architecture of the invention is not limited to the following descriptions.

<Outline>

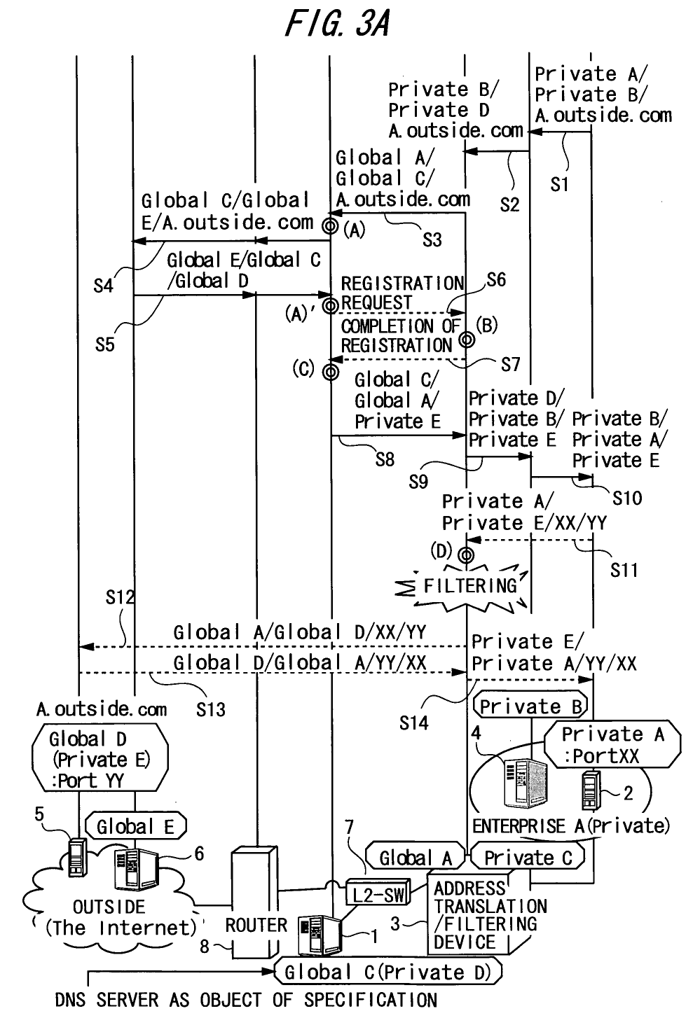

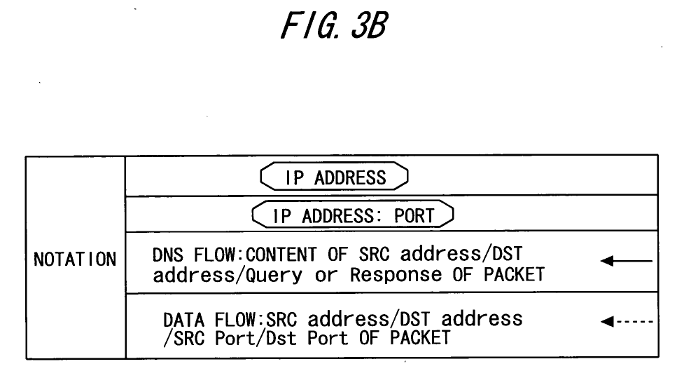

An outline of communications extending over a private IP address space and a global IP address space will be explained by use of FIGS. 3A and 3B. FIGS. 3A and 3B are views showing a communication from a private IP address network to a global IP address network and its notation respectively. In the embodiment, in the communications extending over the private IP address space and the global IP address space, a function which a proxy server has hitherto carried a load of, is shared in role with a DNS server (which is a DNS server 1 having Global C in FIG. 3A) and an address translation device which are located at a boundary between the private IP address network and the global IP address network. Namely, the DNS server 1 takes a role of filtering to a connecting destination on the basis of a name (a host name or a domain name of a wish-to-communicate-with terminal), and functions so as to make data coincident with a specified condition transparent through. The address translation device takes a role of filtering an application in accordance with a port number of the querying destination, and functions as an address translation/filtering device 3 having both of an address translation function and a filtering function. Note that the address translation/filtering device 3 does not have a terminating function as the proxy server has on the application layer, and is to execute an address translation, a session management required therefor and filtering.

Next, requirements arising for actualizing the embodiment will respectively described.

(1) Network Architecture

As a network architecture, mainly requirements added to the conventional network architecture will be explained.

Firstly, in the DNS, in terms of s thereof, a querying source (a communication source) terminal is unable to separately use DNS servers by its being aware of whether a querying destination (a communication destination) terminal resides on the private IP address network or on the global IP address network. Therefore, the DNS server 1 on the private IP address network and a DNS server 5 on the global IP address network are connected to each other on a domain tree.

Secondly, the DNS server 1 is required to deal with both of a name resolution in the private IP address network and a name resolution in the global IP address network. Hence, the DNS server 1 needs belonging also to a domain tree on the side of the global IP address network. Accordingly, the DNS server 1 as an object of the invention is disposed on the global IP address network (on DMZ)

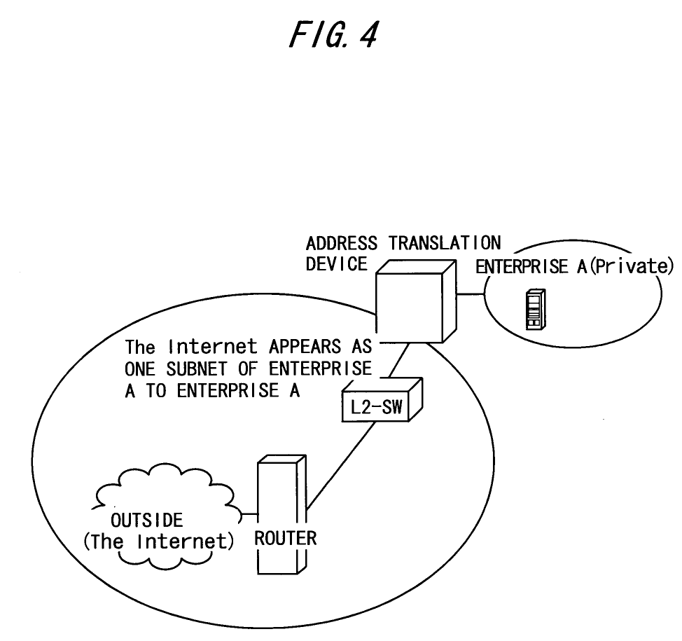

Thirdly, the private IP address network does not include a route to the global IP address network. Therefore, an architecture is built up so that the whole global IP address network appears as a subnet of the private IP address network as viewed from the private IP address network. Namely, as shown in FIG. 4, the architecture is that an outside network (the Internet) appears as one subnet as viewed from the side of an enterprise A.

The requirements according to devices taking the network architecture into consideration will be explained.

(2) DNS Server

Next, the requirements needed for the DNS server 1 as the object of the invention will be explained.

Firstly, the DNS server 1 is constructed to have a name resolution querier identifying function for identifying whether the query is a query from within the global IP address network or a query from within the private IP address network.

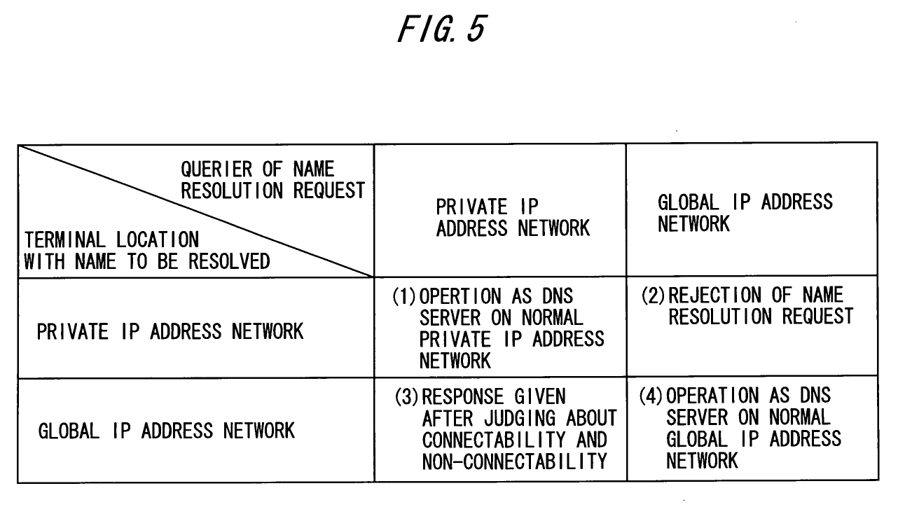

Secondly, the DNS server 1 is constructed to have a function of judging, based on a piece of name resolution querier identifying information, whether a response to the name resolution request aiming at only the name resolution query from within the private IP address network, is possible or not. The DNS server 1 is, because of a connection established between a DNS server on the private IP address network and a DNS server 6 on the global IP address network, so constructed as to be capable of changing a response to the name resolution request in accordance with, for example, as shown in FIG. 5, a querying source and a querying destination (a location of the terminal having a name to be resolved) of the name resolution request.

The response and an operation of the DNS server in accordance with the querying source and the querying destination of the name resolution request, will be explained by use of FIG. 5. First, the DNS server operates as a normal DNS server on the private IP address network with respect to the query (the name resolution request) from the private IP address network to the terminal device (the host) within the private IP address network (which corresponds to (1) in FIG. 5). Second, the DNS server rejects the name resolution request with respect to the name resolution request from the global IP address network to the terminal device within the private IP address network (which corresponds to (2) in FIG. 5). Third, the DNS server gives a response by judging whether to be connectable or not with respect to the name resolution request from the private IP address network to the terminal device within the global IP address network (which corresponds to (3) in FIG. 5). Fourth, the DNS server operates as a normal DNS server on the global IP address network with respect to the name resolution request from the global IP address network to the terminal device within the global IP address network (which corresponds to (4) in FIG. 5).

Note that for the operation in (3), the DNS server 1 manages, together with necessary pieces of information for the name resolution, a port number admitted for every name on the global IP address network in which the connection is permitted. In this case, the DNS server 1 notifies the address translation/filtering device 3 of a mapping (corresponding) port number together with an IP address of a connecting destination. Further, in the operation in (3), the DNS server 1 functions so as to send, as a result of the name resolution, a virtually assigned private IP address back to the terminal as the querying destination on the global IP address network. This virtual address is present in the DNS server 1 by the administrator of the private IP address network.

Third, the DNS server 1 is constructed to have a function of, when giving a response to the name resolution request, making a negotiation with the address translation/filtering device 3 in order to notify the address translation/filtering device 3 of the IP address (the private IP address), the IP address (the global IP address) as an object of the address translation and the port number.

(3) Address Translation/Filtering Device

Next, requirements needed for the address translation/filtering device 3 will be explained. The address translation/filtering device 3 provides a packet filtering function based on the notification from the DNS server 1. Namely, the address translation/filtering device 3 performs filtering a packet received from the private IP address side on the basis of the global IP address serving as a forwarding destination and the port number, an forwards or discards the received packet. Further, the address translation/filtering device 3 has a NAT function, and executes the address translations of the virtually assigned private IP address and the global IP address for every querying destination.

<Network Architecture>

Next, the network architecture for actualizing the embodiment of the invention will be described by use of FIGS. 3A and 3B.

In the example shown in FIG. 3A, a network including a terminal (host) 2 accommodated in a network within an enterprise A and the DNS server 4, is illustrated as the private IP address network. Further, the Internet is shown as the global IP address network, wherein a server (host) 5 and a DNS server 6 are connected to the Internet.

An intermediate zone (DMZ) on the network exists between the private IP address network and the global IP address network. Disposed in the intermediate zone on the network are the DNS server 1 (the DNS server as the object of the invention), the address translation/filtering device 3, a L2-SW7 and a router 8, respectively. The address translation/filtering device 3, the L2-SW (layer switch) 7 and the router 8 are connected in this sequence from the side of the private IP address network, and the DNS server 1 (the DNS server as the object of the invention) is connected to the L2-SW7.

Moreover, the IP addresses (the private IP addresses and the global IP addresses) different from each other are set in the respective servers and the devices configuring the network. In the example shown in FIG. 3A, a global IP address “Global C” and a private IP address “Private D” are set in the DNS server 1 located in the intermediate zone of the network. Further, a global IP address “Global A” and a private IP address “Private C” are set in the address translation/filtering device 3. Moreover, a private IP address “Private B” is set in the DNS server 4 located in the private IP address network. Further, a global IP address “Global E” is wet in the DNS server 6 located in the global IP address network.

Furthermore, IP addresses and port numbers used when utilizing a specified application are assigned to the terminal 2 within the private IP address network and to the server 5 residing in the global IP address network. In the example shown in FIG. 3A, a private IP address “Private A” and a port number “Port XX” are assigned to the terminal 2 located within the private IP address network. Moreover, the server 5 located within the global IP address network is assigned a global IP address “Global D”, a virtually assigned private IP address “Private E” and a port number “Port YY”. Further, the server 5 becomes, in the embodiment, the querying destination and has a name (a host name or a domain name) of “A.outside.com”.

Note that the L2-SW7 and the router 8 function as routing devices for routing a traffic between the private IP address network and the global IP address network. Moreover, the L2-SW7 functions as a changeover switch for forwarding a packet transferred between the router 8 and the address translation/filtering device 3 to the DNS server 1 or for forwarding the packet from the DNS server 1 to the address translation/filtering device 3.

<System Architecture of DNS Server>

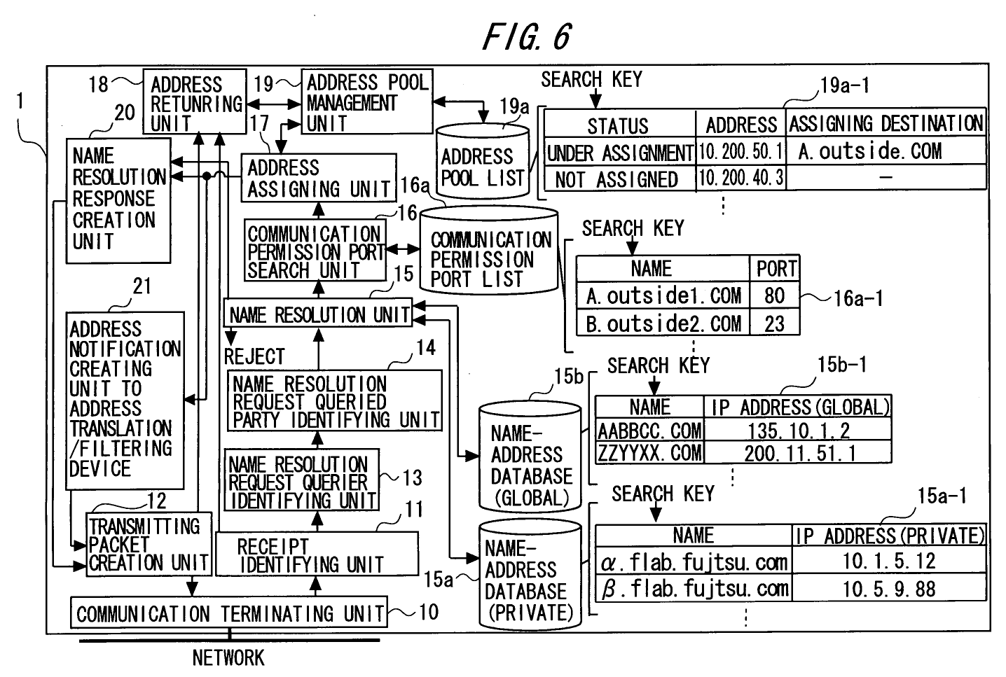

Next, a system architecture of the DNS server 1 for actualizing the embodiment of the invention will be described by use of FIG. 6. FIG. 6 shows a diagram of the system architecture of the DNS server 1.

The DNS server 1 includes a communication terminating unit 10, a receipt identifying unit 11, a transmitting packet creation unit 12, a name resolution request querier identifying unit 13, a name resolution request queried party identifying unit 14, a name resolution unit 15, a communication permission port search unit 16, an address assigning unit 17, an address returning unit 18, an address pool management unit 19, a name resolution response creation unit 20, and a notification creating unit 21 to the address translation/filtering device. The DNS server 1 is constructed by use of an information processing device such as a personal computer, a workstation, etc., and schemes to resolve the name by acquiring the IP address from a name of the querying destination (e.g., a host name or a domain name) in cooperation with other DNS servers 4, 6.

The communication terminating unit 10 electrically terminates the communication from the network. The information received from the network is transferred as a packet to the receipt identifying unit 11. Further, the packet from the transmitting packet creation unit 12 is electrically transmitted to the network.

The receipt identifying unit 11 identifies the packet information (content of the packet). The receipt identifying unit 11 functions so as to take two roles for the packet transmitted. Firstly, the receipt identifying unit 11 judges whether the packet is a normal packet or abnormal packet (such as a case where a frame format is not normal, and so on). Secondly, the receipt identifying unit 11 judges whether the packet is a packet of a name resolution request (a name resolution request packet), a packet for notifying of an address return (a response packet) or a packet other than these.

The transmitting packet creation unit 12 packetizes the information to be transmitted onto the network, and transfers it to the communication terminating unit 10.

The name resolution request querier identifying unit 13 judges based on a type of the source IP address of the name resolution request packet whether the name resolution request querier terminal resides on the global IP address network or on the private IP address network.

The name resolution request queried party identifying unit 14 judges, based on a name of the querying destination, whether the querying destination terminal resides on the global IP address network or on the private IP address network. For example, in FIG. 6, when the name resolution querying destination contains a domain name “fujitsu.com”, it is judged that the request is a name resolution request for the terminal within the private IP address network, and, in other cases, it is judged that the request is the name resolution request for the terminal within the global IP address network. Note that a judging condition (fujitsu.com) herein is previously designated.

The name resolution unit 15 judges, based on the results of the judgment by the name resolution request querier identifying unit 13 and the name resolution request queried party identifying unit 14, which category among (1), (2), (3), (4) shown in FIG. 5 the name resolution request received comes under, and executes a process corresponding thereto, respectively. Namely, the name resolution unit 15, when judging that the name resolution request comes under (1), searches a name/address database 15a (private) managed by itself. Further, the name resolution unit 15, when judging that the name resolution request comes under (2), rejects the name resolution request. Further, Moreover, the name resolution unit 15, when judging that the name resolution request comes under (3) or (4), searches a name/address database (global) 15b managed by itself. Note that the judging condition (for example, FIG. 5) herein is preset.

Each of the name/address databases 15a, 15b is linked to the name resolution unit 15. The name/address databases 15a, 15b respectively have tables 15a-1, 15b-1 that retain mappings between the names of the querying destinations and the IP addresses as responses thereto.

The communication permission port search unit 16, when the name resolution request comes under (3) shown in FIG. 5, searches a self-managed communication permission port list 16a for a port with its connection permitted.

The communication permission port list 16a is a database which is linked to the communication permission port search unit 16 and contains a table 16a-1 showing a list of names of the querying destinations and of port numbers (application) permitting the communication to the querying destination. The communication permission port list 16a searches, from the name of the querying destination, for the port number permitted for this name and sends it as a search result back to the communication permission port search unit 16. Further, when the search result is not yet hit, the communication is not permitted. Note that contents of the communication permission port list 16a are preset.

The address assigning unit 17, when the name resolution request comes under (3) shown in FIG. 5, through the address pool management unit 19, searches an address pool list 19a for a temporary address (a virtual private IP address) to the name resolution request of which the private IP network side is notified.

The address returning unit 18 writes the IP address (the private IP address) returned from the address translation/filtering device 3 to the address pool list 19a through the address pool management unit 19.

The address pool management unit 19 manages the address pool list 19a, and executes an address search process and an address registration process with respect to the address pool list 19a in cooperation with the address assigning unit 17 or the address returning unit 18.

The address pool list 19a is a database containing a table 19a-1 showing a list of corresponding relationships between the temporary address (the virtual private IP addresses) to the name resolution request of which the private IP network side is notified and assignment statuses thereof. The assignment status is indicated by “under assignment” or “not yet assigned”. Further, when the assignment status is “under assignment”, a name of an assignment destination is also retaining mapping thereto.

The name resolution response creation unit 20 creases a response to the querying source of the name resolution request. In this case, when the search becomes successful in the name resolution unit 15, a response containing a resolved IP address as a content is. Further, when the search falls into a failure in the name resolution unit 15, a response containing the failure in the name resolution as a content is generated.

The notification creating unit 21 to the address translation/filtering device, when the name resolution request comes under (3) shown in FIG. 5, generates a content of a notification to the address translation/filtering device 3. The contents of the notification are firstly the port number acquired by the communication permission port search unit 16, secondly the private IP address acquired by the address assigning unit 17, thirdly the global IP address acquired by the name resolution unit 15, and fourthly the name of the querying destination.

<System Architecture of Address Translation/Filtering Device>

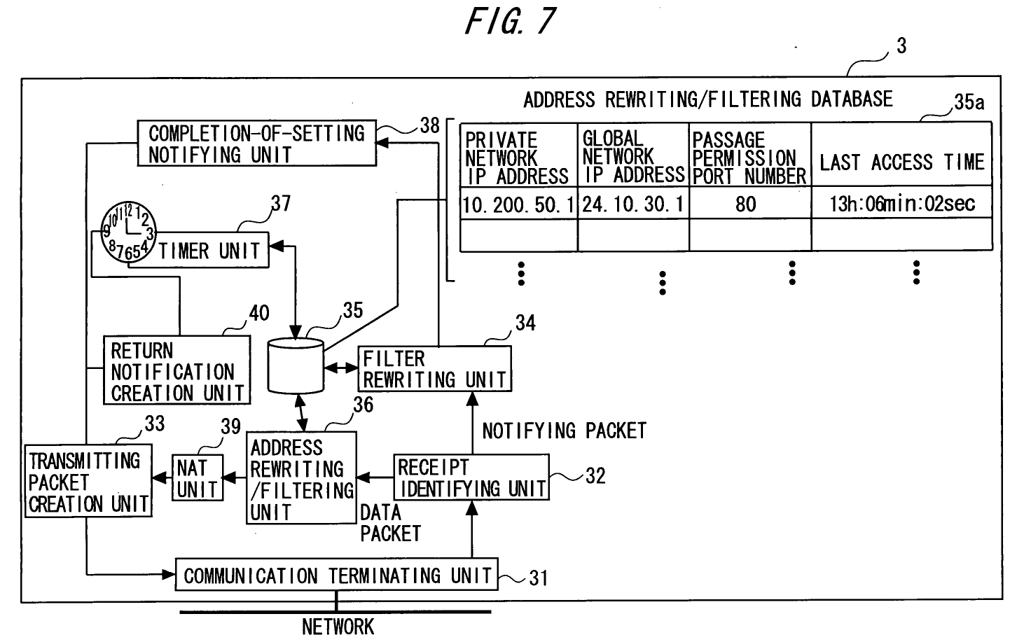

Next, a system architecture of the address translation/filtering device 3 for actualizing the embodiment of the invention will be explained by use of FIG. 7. FIG. 7 shows a diagram of the system architecture of the address translation/filtering device 3.

The address translation/filtering device 3 includes a communication terminating unit 31, a receipt identifying unit 32, a transmitting packet creation unit 33, a filter rewriting unit 34, and address rewriting/filtering unit 36, a timer unit 37, a completion-of-setting notifying unit 38, a NAT unit 39, a return notification creating unit 40, and an address rewrite/filter database 35. The address translation/filtering device 3 is constructed by use of an information processing device such as a personal computer, a workstation, etc. having a communication function, and has both of an address translation function based on the NAT (NAPT: Network Address Port Translation) and a function of filtering the packet on the basis of the IP address and the port number of every packet received.

The communication terminating unit 31 electrically terminates the communication from the network. The information received from the network is transferred as a packet to the receipt identifying unit 32. Further, the packet from the transmitting packet creation unit 33 is electrically transmitted to the network.

The receipt identifying unit 32 identifies the packet information. The receipt identifying unit 32 functions so as to take two roles for the packet transmitted. Firstly, the receipt identifying unit 32 judges whether the packet is a normal packet or abnormal packet (such as a case where a frame format is not normal, and so on). Secondly, the receipt identifying unit 32 judges whether the packet is a notification packet from the DNS server 1 or a data packet other than this.

The transmitting packet creation unit 33 packetizes the information to be transmitted onto the network, and transfers it to the communication terminating unit 31.

The filter rewriting unit 34 rewrites, based on the received notification packet, an address rewriting/filtering database 35a. Contents to be rewritten are firstly the private IP address acquired by the communication permission port search unit 16 of the DNS server 1 and which the address translation/filtering device has been notified of, secondly the global IP address acquired by the name resolution unit 15 of the DNS server 1 and which the address translation/filtering device has been notified of, and thirdly the port number acquired by the communication permission port search unit 16 of the DNS server 1 and which the address translation/filtering device has been notified of.

The address rewriting/filtering database 35 is created based on the notification packet from the DNS server 1. The database 35 has a table 35a retaining a list in which each one entry is a mapping between the private IP address, global IP address, the communication permission port number and the last access time. Further, the address rewriting/filtering database 35 is linked to the filter rewriting unit 34, the address rewriting/filtering unit 36 and the timer unit 37, wherein they function in linkage with each other.

The address rewriting/filtering unit 36 rewrites the data for every data packet. Firstly, the address rewriting/filtering unit 36, for the packet from the private IP address network to the global IP address network, to start with, searches the address rewriting/filtering database 35 on the basis of the destination IP address (the private IP address) of the packet, and rewrites the global IP address mapping thereto as a packet destination IP address. Simultaneously, it checks whether the packet destination port number is coincident with a port number as a search result. In the case of being coincident, the packet is sent to the global IP address network, and, in the case of not being coincident, the packet is discarded. Moreover, the address rewriting/filtering unit 36 updates the last access time in the address rewriting/filtering database 35. Secondly, the address rewriting/filtering unit 36, for the packet from the global IP address network to the private IP address network, to begin with, searches the address rewriting/filtering database 35 on the basis of the packet source IP address (the global IP address), and rewrites the private IP address (the virtual address) mapping thereto as a packet source IP address. Further, it checks whether the packet source port number is coincident with a port number as a search result. In the case of being coincident, the packet is sent to the private IP address network, and, in the case of not being coincident, the packet is discarded. Moreover, the address rewriting/filtering unit 36 updates the last access time in the address rewriting/filtering database 35.

The timer unit 37 periodically confirms the last access time in each entry of the address rewriting/filtering database 35, and, when there is an entry receiving no access for a fixed period of time, deletes this entry.

The completion-of-setting notifying unit 38 generates information (notifying information) for notifying the DNS server 1 that the rewrite of the address rewriting/filtering database 35 on the basis of the notification packet received from the DNS server 1 has been ended. The notifying information contains a filtering/rewriting end notification, the port number acquired by the communication permission port search unit 16, the private IP address acquired by the address assigning unit 17, the global IP address acquired by the name resolution unit 15 and the name of the querying destination.

The NAT unit 39 executes a NAT (NAPT) process (defined in RFC3022). Namely, the NAT unit 39 executes a translation process between the global IP address and the private IP address.

The return notification creating unit 40 notifies the DNS server 1 of information in other entries (effective entries) excluding the entry containing the last access time in the address rewriting/filtering database 35 in which a timeout has been detected by the timer unit 37.

<Data Structure of Packet>

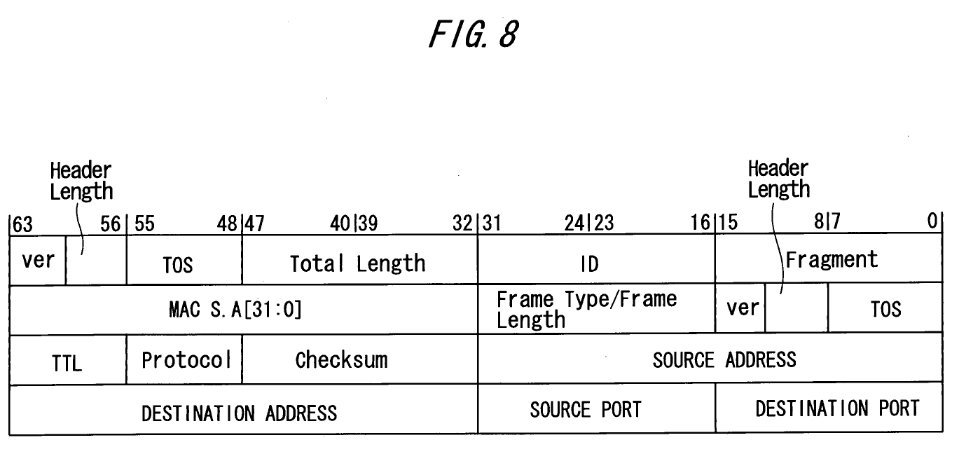

Next, a data structure of the packet transferred and received in the embodiment will be explained by use of FIG. 8.

FIG. 8 is a diagram showing a format of the packet transferred and received between the private IP address space and the global IP address space.

As shown in FIG. 8, a packet 100 contains fields indicating a destination IP address, source IP address, a destination port number and a source port number, and fields indication other pieces of control information, etc. Note that the packet 100 will be described in a way that picks up the destination IP address, the source IP address, the destination port number and the source port number related to the embodiment.

The packet transmitted to the global IP address network from the private IP address network is, on the occasion of passing though the address translation/filtering device 3, rewritten in its field of the destination IP address by the address rewriting/filtering unit 36. Further, the NAT unit 39 within the address translation/filtering device 3 rewrites the field of the source IP address and the source port number by a normal NAT (NAPT) process.

The packet transmitted to the private IP address network from the global IP address network is, on the occasion of passing though the address translation/filtering device 3, rewritten in its field of the source IP address by the address rewriting/filtering unit 36. Further, the NAT unit 39 within the address translation/filtering device 3 rewrites the fields indicating the destination IP address and the destination port number by the normal NAT (NAPT) process.

<Operation Flow>

Specific operations for actualizing the embodiment will be explained for every pattern by use of FIGS. 3A and 3B and FIGS. 9 through 15.

[Communication to Global IP Address Network from within Private IP address Network]

(1) Communication Permitting Time

FIG. 3A is a processing sequence showing the communication from the private IP address network to the global IP address network at a communication permitting time. The contents of the packet transferred and received between the networks will hereinafter be expressed as “source address (SRC address)/destination address (DST address)/query or response (Query or Response)” at a DNS flow time (which is the communication concerning the name resolution) on the drawings. Further, they are expressed as “source address (SRC address)/destination address (DST address)/source port number (SRC Port)/destination port number (DST port)” at a data flow time (which is the communication related to a start of actual accessing). Note that the packet at the DNS flow is drawn by a solid line, while the packet at the data flow time is drawn by a dotted line on the drawings.

In FIG. 3A, the packet from the terminal 2 accommodated in the private IP address network (the network within the enterprise A) towards the server 5 accommodated in the global IP address network (the Internet), is forwarded across between the IP networks via the address translation/filtering device 3, the L2-SW7 and the router 8 installed between the terminal 2 and the server 5. Each of the DNS servers 1, 4, 6 is utilized for the terminal 2 and the server 5 to know the IP addresses. Then, the address translation/filtering device 3 controls the address translation and the filtering of the packet forwarded across between the IP networks. Herein, the description is made on the assumption that the intermediate zone (DMZ) on the network that is located between the private IP address network (the network within the enterprise A) and the global IP address network (the Internet), exists between the address translation/filtering device 3 and the router 8 (which will hereinafter be called a gray zone). Note that on the occasion of performing the communications between the terminal 2 and the server 5, explanations of the operations thereof, though via the L2-SW7 and the router 8, are omitted.

To begin with, when forwarding the packet to the server 5 from the terminal 2 accommodated in the private IP address network (the network within the enterprise A), the terminal 2, for knowing the IP address of the server 5, transmits a name resolution request packet addressed to the DNS server residing within the same network (S1). In this case, the packet to be transmitted contains “Private A (terminal 2 private IP address: source address)”, “Private B (DNS server 4 private IP address: destination address)”, and “A.outside.com (query: name of name resolution object host (server 5)”.

Next, the DNS server 4 is unable to solve the name resolution request by the self-possessed zone information and therefore transmits a name resolution request packet of which the destination address is set to the DNS server 1 located on the gray zone (S2). The name resolution request packet at this time contains “Private B (DNS server 4 private IP address: source address)”, “Private D (DNS server 1 private IP address: destination address)” and “A.outside.com (query: host name of server 5)”. On the gray zone, the name resolution request packet transmitted from the DNS server 4 flows via the address translation/filtering device 3. The address translation/filtering device 3 sends the packet in which the source IP address and the destination IP address of the name resolution request packet are translated into global IP addresses from the private IP addresses (S3). The name resolution request packet after passing through the address translation/filtering device 3 thereby contains “Global A (the address translation/filtering device 3 global IP address: source address)”, “Global C (DNS server 1 global IP address: destination address)”, and “A.outisde.com”.

Subsequently, the DNS server 1 located on the gray zone is unable to solve the name resolution request by the self-possessed zone information and therefore transmits the name resolution request packet addressed to the DNS server 6 accommodated in the global IP address network (S4). This name resolution request packet contains “Global C (DNS server 1 global IP address: destination address)”, “Global E (DNS server 6 global IP address: destination address)” and “A.outisde.com”.

The DNS server 6 performs the name resolution on the basis of the name resolution request packet received from the DNS server 1 and, as a result, acquires the global IP address (Global D) of the server 5. Then, the DNS server 6 sends a packet (a response packet) containing the result of the name resolution) to the DNS server 1 as it is addressed thereto (S5). Namely, it sends the response packet containing the IP address corresponding to the query (A.outside.com) of the name resolution request packet. The response packet contains “Global E (source address)”, “Global C (destination address)” and “Global D (response: global IP address corresponding to the name)”.

The DNS server 1 receives the response packet from the DNS server 6. Then, the DNS server 1 obtains the port number (an application identifier) permitted for the name (the host name) of the server 5, thereby judging whether the communication is to be permitted or not. An assumption herein is that a port number “Port YY” be searched for, and the communication be permitted. When permitting the communication, the DNS server 1 acquires the virtual private IP address Private E assigned to the server 5, and sends to the address translation/filtering device 3 a notification packet (a registration request) containing this “Private E”, “Global D” and “Port YY (the communication permission port number)” (S6).

The address translation/filtering device 3 registers the contents of the notification packet from the DNS server 1 in the database 35. Upon a completion of the registration, it sends a packet notifying of the completion of the registration back to the DNS server 1 (S7).

The DNS server 1, upon receiving the notification of the completion of the registration, assembles a response packet to the DNS server 4, and transmits it to the address translation/filtering device 3 as it is addressed thereto (S8). The response packet contains “Global C (source address)”, “Global A (destination address)”, and “Private E (response: virtual private IP address corresponding to the name)”. At this time the DNS server 1 translates, by way of a response, the global IP address of the server 5 into the virtual private IP address. This enables, in its destination, a recognition that the response packet has been transmitted from the host in the private IP network.

The address translation/filtering device 3 executes an address translation of the source address and the destination address of the response packet received from the DNS server 1 into the private IP addresses from the global IP addresses, and sends them to the DNS server 4 as it is addressed thereto (S9). At this time, the response packet contains “Private D (source address)”, “Private B (destination address)”, and “Private E”.

The DNS server 4, upon receiving the response packet, sends to the terminal 2 the response packet to the name resolution request (S10). At this time, the response packet contains “Private B (source address)”, “Private A (destination address)”, and “Private E”.

The terminal 2 having transmitted the name resolution request packet detects, from the contents of the response packet received from the DNS server 4, that the response is “Private E”. Namely, the terminal 2 knows that the IP address corresponding to the queried name (A.outside.com) is “Private E”.

The terminal 2, for starting the communication with the server 5, sends the data packet (S11). In this case, “Private A (source address)”, “Private E (destination address)”, “XX (source port number)” and “YY (destination port number)” are set in the header of the data packet.

The data packet transmitted from the terminal 2 passes through the address translation/filtering device 3 on the gray zone. At this time, the address translation/filtering device 3 judges based on the destination port number of the data packet whether the communication is possible or not, then judges, if the destination port number is a port number with the communication permitted, that the communication is possible, and lets the data packet pass through in a way that performs an address translation of the destination address and the source address of this data packet into the global IP addresses from the private IP addresses. At this time, there comes to a state where the header of the data packet sent from the address translation/filtering device 3 contains “Global A (source address)”, “Global D (destination address)” “XX (source port number)”, and “YY (destination port number)” (S12).

The server 5, upon receiving the data packet from the terminal 2, sends the data packet to the querier terminal 2 as the transmitting source of this packet (S13). In this case, the header of the data packet has “Global D (source address)” “Global A (destination address)”, “YY (source port number)”, and “XX (destination port number)” (S13).

The data packet sent from the server 5 passes through the address translation/filtering device 3 on the gray zone. At this time, the destination address and the source address of the data packet are translated into the private IP addresses from the global IP addresses. This being done, there comes to a state where the header of the data packet sent from the address translation/filtering device 3 contains “Private E (source address)”, “Private A (destination address)”, “YY (source port number)”,and “XX (destination port number)” (S14).

### Operation Flow of DNS Server 1 between A-A′ and Point C

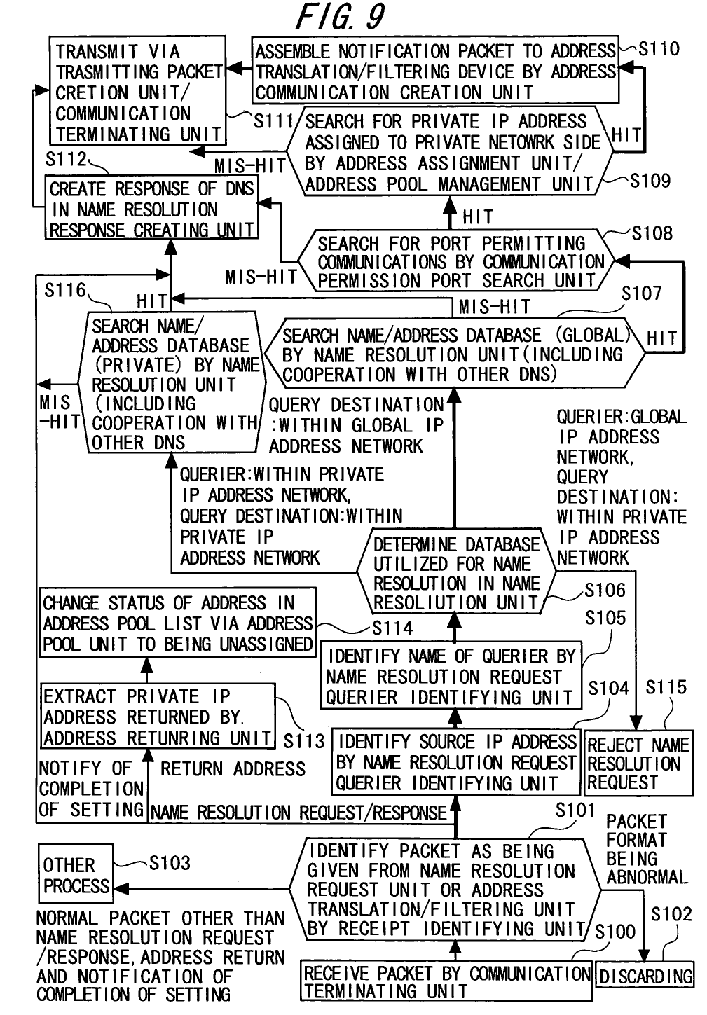

Next, an operation of the DNS server 1 for actualizing the embodiment in FIGS. 3A and 3B will be described by use of FIG. 9.

FIG. 9 is a flowchart showing an operating process of the DNS server 1 in FIG. 3A. The DNS server 1 operates upon a trigger of receiving the packet from on the network. The communication terminating unit 10 receives the packet from on the network (S100).

The receipt identifying unit 11 identifies as to whether the packet is the name resolution request packet, or whether the packet is a packet from the address rewriting/filtering unit 36 in the address translation/filtering device 3 (S101).

At this time, in the case of the packet format being abnormal, the packet is discarded (S102). Further, in the case of a normal packet other than of the name resolution request/response, the address return and the completion-of-setting notification, other process corresponding to this packet is executed (S103).

Given first is an explanation in a case where the receipt identifying unit 11 of the DNS server 1 identifies the packet with the name resolution request/response (S101). In S101, when the packet is identified with the name resolution request/response, the name resolution request querier identifying unit 13 identifies a network type of the querying source on the basis of the source IP address of the packet (S104). Subsequently, the packet is transferred to the name resolution request queried party identifying unit 14, wherein a network type of the querying destination is identified based on a name of the querying destination (S105). Namely, the name resolution request querier identifying unit 13 and the name resolution request queried party identifying unit 14 identify as to whether the querying source or the querying destination is the private IP address network or the global IP address network.

Based on a result of the identification made by the name resolution request querier identifying unit 13 and the name resolution request queried party identifying unit 14, the name resolution unit 15 determines a database utilized for the name resolution (S106). Namely, as shown in FIG. 5, a process corresponding to a combining condition of the querying source and the querying destination of the name resolution request, is carried out.

At this time, when both of the querying source and the querying destination belong to the private IP address network, the processing proceeds to S116, wherein the operation of (1) in FIG. 5 is conducted. On the other hand, when the querying source comes under the global IP address network and when the querying destination comes under the private IP address network, the communication to the private IP address network from the global IP address network is inhibited, and hence the name resolution request is rejected. ((2) in FIG. 5).

In S106, when the IP address indicating the querying destination of the packet is an address within the global IP address network, i.e., when corresponding to (3), (4) in FIG. 5, the name resolution unit 15 searches the name/address database (global) 15b (S107). At this time, the DNS server 1 can also perform, in cooperation with other DNS servers, the name resolution by receiving the IP address of a translation destination that is acquired in other servers. For instance, in the example shown in FIG. 3A, the DNS server 1 obtains the IP address “Global D” of the translation destination in cooperation with the DNS server 6.

In S107, as a result of the name resolution unit 15 having searched the name/address database (global) 15b, when the IP address concerned is hit, the communication permission port search unit 16 searches the communication permission port list 16a for a port number enabling the communication with its name used as a search key (S108). In the example shown in FIG. 3A, “Port YY” is obtained as the port number for the application that is permitted for the name. Note that when nothing is hit as a result of the search in S108 (which will hereinafter be termed “mis-hit”), this results in a failure of the name resolution, thus proceeding to S112. This is for exculding the communication of the unpermitted application.

Further, in S107, as a result of the name resolution unit 15 having searched the name/address database (global) 15b (including a result of the cooperation), when the mis-hit occurs, the response to the querying source comes to the failure of the name resolution, and the name resolution response creating unit 20 creates (generates) a response to the DNS server 1 (S112).

As a result of the search in S108, when a port number corresponding to the name is hit, the address assigning unit 17 searches, through the address pool management unit 19, the address pool list 19a for a private IP address to be assigned to the private network side (S109). In the example shown in FIG. 3A, in S109, a virtual private IP address “Private E” that should be assigned to “Global D” is obtained from the address pool list 19a. When the search in S109 results in the mis-hit, this falls into the failure of the name resolution, thus proceeding to S112.

In the result of the search in S109, when the private IP address concerned is hit, the address notification creating unit 21 assembles a notification packet (a registration request packet) to the address translation/filtering device 3 (S110).

The notification packet contains the IP address (response) of the communication destination, the port number, the source IP address, the destination IP address and the name. In the example shown in FIG. 3A, the notification packet containing “Private E”, “Port YY”, “Global D”, “Private A” and “A.outside.com” is assembled.

The notification packet to be eventually transmitted is transferred to the transmitting packet creation unit 12 and transmitted via the communication terminating unit 10 (S111).

The above is the operation of the DNS server 1 between A-A′ in FIG. 3A in the communication to the global IP address network from the private IP address network at the communication permitting time shown in FIG. 3A. The DNS server 1 executes, between A-A′, the existing DNS process in cooperation with the DNS server 6 having “Global E”. Namely, as shown in FIG. 9, the DNS server 1 operates, between A-A′, in the sequence such as S100-S101-S104-S105-S106-S107-S108-S109-S110-S111.

Given next is a description of a case in which the receipt identifying unit 11 of the DNS server 1 identifies the packet with the completion-of-setting notification (S101). In S101, when the receipt identifying unit 11 identifies the packet with the completion-of-setting notification, the name resolution response creation unit 20 creases a DNS response containing the private IP address extracted from the address pool list 19a as a response to the querying source (S112). In the example shown in FIG. 3A, a response packet containing “Private E” as the private IP address becoming the response to the querying source is assembled.

Eventually, the response packet sent in S8 in FIG. 3A is transferred to the transmitting packet creation unit 12 and sent via the communication terminal unit 10 (S111).

The above is the operation of the DNS server 1 at the point C in FIG. 3A in the communication to the global IP address network from the private IP address network at the communication permitting time shown in FIG. 3A. The DNS server 1, at the point C, operates in the sequence such as S100-S101-S112-S111 upon a trigger of receiving a completion-of-registration notification packet from the address translation/filtering device 3.

### Operation Flow of Address Translation/Filtering Device 3 at Points B and D

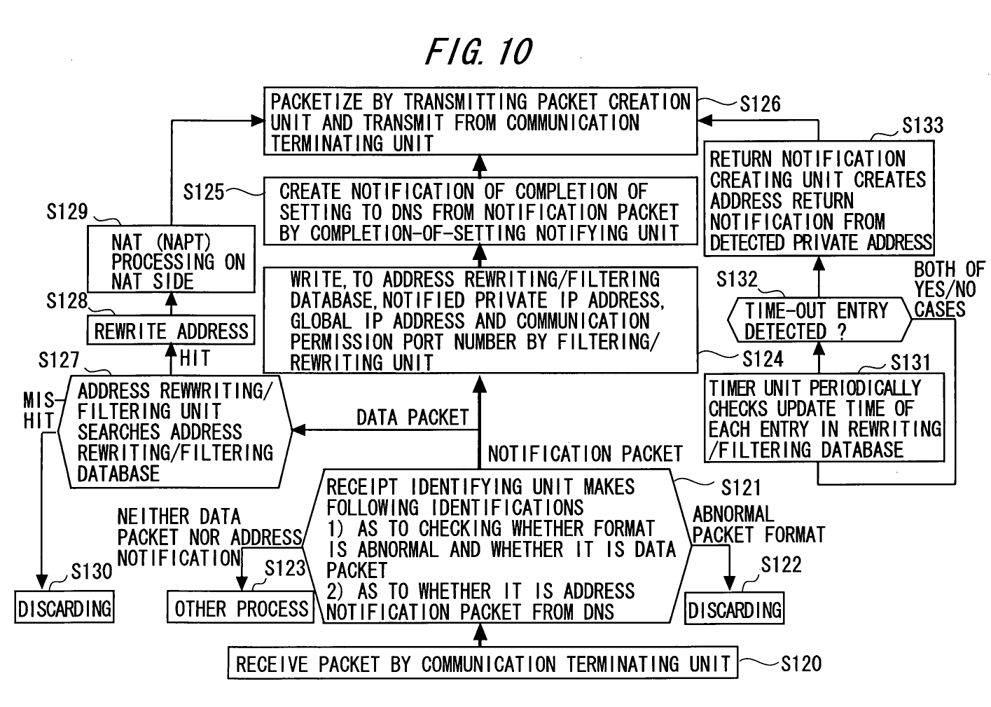

Next, an operation of the address translation/filtering device 3 for actualizing the embodiment in FIG. 3A will be explained by use of FIG. 10.

FIG. 10 is a flowchart showing an operation process of the address translation/filtering device 3 in FIG. 3A. The address translation/filtering device 3 operates upon a trigger of receiving the packet from on the network. The communication terminating unit 31 receives the packet from on the network (S120).

The receipt identifying unit 32 identifies as to whether the packet is the data packet assembled in a normal packet format (it is also checked whether the format is the normal packet format) or whether the packet is the notification packet (the registration request packet from the DNS server 1 (S121).

In S121, when the packet format is abnormal, this packet is discarded (S122). In S121, when the packet is neither the data packet nor the notification packet, other process corresponding to this packet is executed (S123).

To start with, a case in which the receipt identifying unit 32 within the address translation/filtering device 3 identifies the received packet with the notification packet (S121) will be explained. In S121, in the case of being identified with the notification packet, the filter rewriting unit 34 is notified of this, wherein the private IP address, the global IP address and the communication permission port number that are contained in the notification packet are written into the address rewriting/filtering database 35 (S124).

In the example shown in FIG. 3A, “Private E”, “Global D” and “Port YY” contained in the notification packet are written into the database by the filter rewriting unit 34.

Subsequently, the completion-of-setting notifying unit 38 creates a completion-of-setting notification to the DNS server 1 on the basis of the notification packet (S125). In this case, the completion-of-setting notification contains a private IP address of the communication destination, a global IP address of the communication destination, a communication permission port number, a name of the communication destination, and an end-of-rewrite notification. In the example shown in FIG. 3A, the completion-of-setting notification containing “Private E”, “Global D”, “Port YY”, “A.outside.com” and the end-of-rewrite notification, is generated.

Subsequently, the transmitting packet creation unit 33 packetizes the completion-of-setting notification created in S125, and transmits it by way of a registration of the completion (S7 in FIG. 3A) to the DNS server 1 through the communication terminating unit 31 (S126).

The above is the operation of the address translation/filtering device 3 at the point B in FIG. 3A in the communication to the global IP address network from the private IP address network at the communication permitting time shown in FIG. 3A. Namely, the address translation/filtering device 3, at the point B, operates in the sequence such as S120-S121-S124-S125-S126 upon a trigger of receiving (S6) the notification packet from the DNS server 1.

Given next is a description of a case in which the receipt identifying unit 32 within the address translation/filtering device 3 identifies the received packet with the data packet (S121). In S121, in the case of being identified with the data packet, the address rewriting/filtering unit 36 is notified of this, and the address rewriting/filtering unit 36 searches the address rewriting/filtering database 35, wherein the destination IP address of the data packet is used as a key (S127).

At this time, the address rewriting/filtering unit 36, when the IP address corresponding to the destination IP address (the private IP address corresponding to the global IP address as the destination IP address) is hit, compares the port number stores in the entry concerned with the destination port number of the data packet, and judges whether or not both of the numbers are coincident with each other. Then, when the both of the numbers are coincident with each other, the packet is judged (hit) to the data packet of which forwarding is permitted, and the processing advances to S128. By contrast, when there is not IP address corresponding to the search key, or when the destination port number of the data packet is not, though the IP address mapping thereto exists, coincident with the port number with the communication permitted (mis-hit), the processing proceeds to S130.

In the case of being hit as a result of the search in S127, the address of the data packet is rewritten (S128). In the example shown in FIG. 3A, the destination IP address of the packet is rewritten to “Global D” from “Private E”. Subsequently, the NAT unit 39 executes the general NAT (NAPT) process (S129). The transmitting packet creation unit 33 packetizes the data undergoing the NAT process in S129, and transmits it through the communication terminal unit 31 (S126).

Further, in the case of being mis-hit as a result of the search in S127. This packet is discarded (S130). The communication to the IP address with no permission and the communication utilizing the unpermitted application, are thereby filtered.

The above is the operation of the address translation/filtering device 3 at the point D in FIG. 3A in the communication to the global IP address network from the private IP address network at the communication permitting time shown in FIG. 3A. Namely, the address translation/filtering device 3, at the point D, operates in the sequence such as S120-S121-S127-S128-S129-S126 upon a trigger of receiving (S11) the data packet from the terminal 2.

According to the invention, on the boundary between the private IP address space and the global IP address space, the DNS server functions of sharing the roles needed for the two address spaces in cooperation with the address translation/filtering device 3, thereby enabling the communications extending over to the global IP address space from the private IP address space.

(2) Return of Private IP Address

Next, a process of returning the private IP address in the communication (corresponding to (3) in FIG. 5) from within the private IP address network into the global IP address network, will be explained by use of FIGS. 9, 10, 11A and 11B.

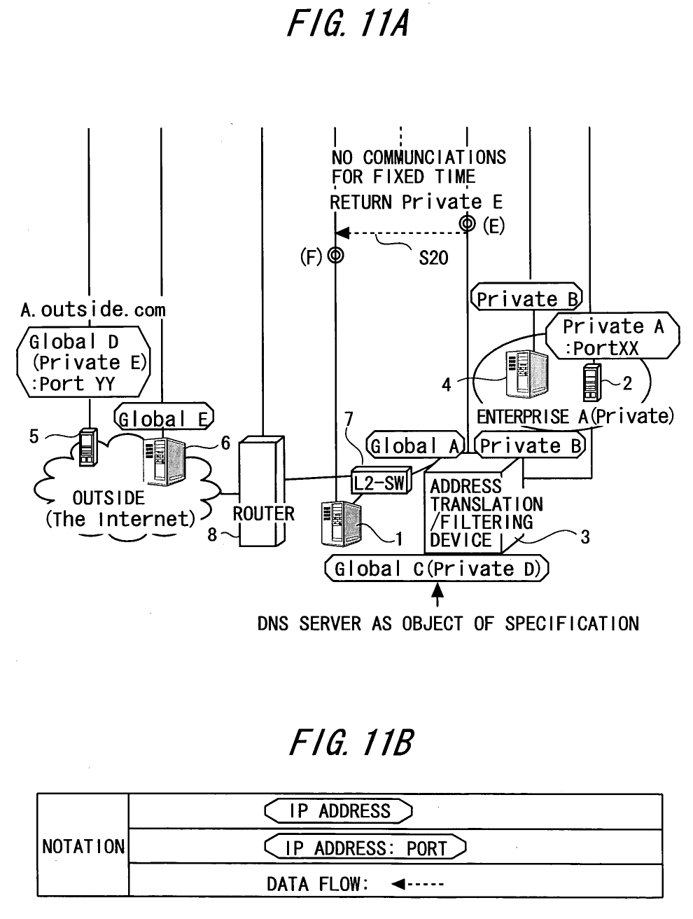

FIGS. 11A and 11B are a processing sequence showing a process of returning the private IP address and its notation respectively. In FIG. 11A, the address translation/filtering device 3 executes returning the private IP address to the DNS server 1 when the timer unit 37 of the address/filtering device 3 detects a timeout because of no data flow for a fixed period of time.

The address translation/filtering device 3, when no communication for the fixed period of time, returns to the DNS server 1 the private IP address acquired by the address assigning unit 17 of the DNS server 1 (S21). In the example shown in FIG. 3A, “Private E” is returned to the DNS server 1.

### Operation Flow of the Address Translation/Filtering Device 3 at Point E

Next, a process at the point E in FIG. 11A will be explained by use of FIG. 10.

The address translation/filtering device 3, upon a trigger of having a result of monitoring by the timer unit 37, executes the returning process of the private IP address. The timer unit 37 of the address translation/filtering device 3 periodically monitors an update time of each entry in the address rewriting/filtering database 35 (S131). By monitoring in S131, or when there is not data flow for the fixed period of time, the entry falling into the timeout is detected (S132). When detecting the timeout entry, the return notification creating unit 40 creates an address return notification from the private IP address of this entry (S133). The transmitting packet creation unit 33 packetizes the address return notification created in S133, and transmits the return notification of the private IP address to the DNS server 1 through the communication terminating unit 31 (S126). In an example shown in FIG. 11A, “Private E” is returned.

The above is the operation of the address translation/filtering device 3 at the point E in FIG. 11A in the communication to the global IP address network from the private IP address network illustrated in FIG. 11A. Namely, the address translation/filtering device 3, at the point E, operates in the sequence such as S131-S132-S133-S126 when there is not data flow for the fixed period of time.

### Operation Flow of DNS server 1 at Point F

Next, a process at a point F in FIG. 11A will be described by use of FIG. 9.

The DNS server 1 operates upon a trigger of receiving the packet from on the network. The communication terminating unit 10 receives the packet from on the network (S100).

The receipt identifying unit 11 identifies as to whether the packet is a name resolution request packet or a packet from the address rewriting/filtering unit 36 within the address translation/filtering device 3 (S101). Namely, at the point F in FG. 11, the receipt identifying unit 11 identifies the received packet with the packet when returning the address from the address translation/filtering device 3.

When the receipt identifying unit 11 identifies the packet with the address return packet, the address returning unit 18 extracts the private IP address to be returned (S113). Subsequently, the address returning unit 18 changes, through the address pool management unit 19, an address status in the address pool list 19a to a not-yet-assigned status (S114).

The above is the operation of the DNS server 1 at the point F in FIG. 11A in the communication to the global IP address network from the private IP address network illustrated in FIG. 11A. Namely, the DNS server 1, at the point F, operates in the sequence such as S100-S101-S113-S114 when there is not data flow for the fixed period of time.

According to the invention, in the communications extending over to the global IP address space from the private IP address space, when there is no communication for the fixed period of time, the function is that the name resolution request under the execution is terminated so as to prevent the name resolution from being executed. Namely, when there is not communication for the fixed period of time after the IP address has been once assigned, it is feasible to prevent the futile virtual address assignment by returning the address.

(3) Rejecting communication due to name

Next, the communication (corresponding to (3) in FIG. 5) from within the private IP address network into the global IP address network, which is rejected due to name, will be explained by use of FIGS. 9, 10, 12.

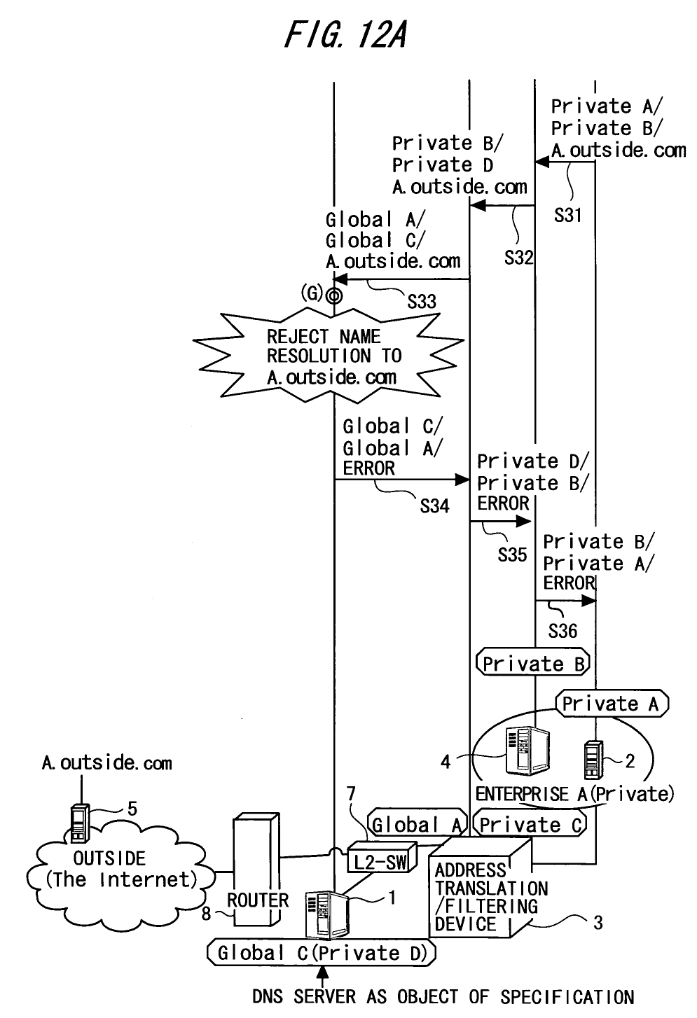

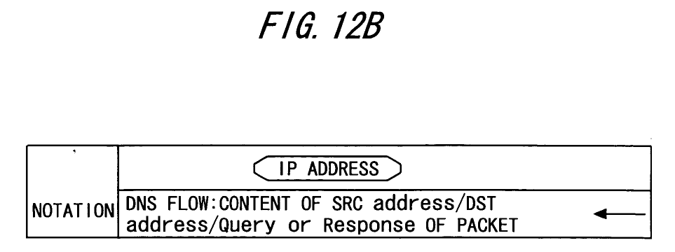

FIGS. 12A and 12B are a processing sequence showing the communication from within the private IP address network into the global IP address network when rejecting the communication on the basis of the name and its notation respectively. Herein, the explanation is made on the assumption of a case of inhibiting the communication to the server 5 having a name “A.outisde.com”. Note that FIG. 12A shows a process executed when rejecting the name resolution in S3 in FIG. 3A, wherein S31 and S32 are the same as S1 and S2 in FIG. 3A, and hence their explanations are omitted.

The DNS server 1 receives the address-translated packet in the address translation/filtering device 3. The name resolution request packet at this time contains[Global A (source address)], [Global C (destination address)], and [A.outside.com] (S33).

The DNS server 1 judges whether the communication with the terminal having the name “A.outisde.com” contained in the name resolution request packet is permitted or unpermitted. That is, the DNS server 1 searches the communication permission port list 16a as to whether “A.outisde.com” exists therein or not. When “A.outisde.com” does not exist in the communication permission port list 16a, the name resolution to the name resolution request packet in S33 is rejected. Namely, the DNS server 1 sends a response packet containing a name resolution failure (ERROR) as a response to the query to the address translation/filtering device 3 (S34).

The address translation/filtering device 3 address-translates the source address and the destination address of the response packet received from the DNS server 1 into the private IP addresses from the global IP addresses, and sends the response packet containing the name resolution failure (ERROR) to the DNS server 4 as it is addressed thereto (S35).

The DNS server 4, upon receiving the response packet, sends to the terminal 2 the response packet containing the name resolution failure (ERROR) to the name resolution request (S36).

### Operation Flow of DNS Server 1 at Point G

Next, a process at a point G in FIG. 12A will be explained by use of FIG. 9. S100 through S107 in FIG. 12A are the same as those in the communication from within the private IP address network to the global IP address network at the communication permitting time in FIG. 3A. Accordingly, as shown in FIG. 12A, a process when rejecting the communication on the basis of the name will be described starting from S108 in FIG. 9.

In S108, the communication permission port search unit 16, in a case where nothing is hit as a result of searching the communication permission port list 16a for a port number enabling the communication, the response to the querying source falls into a name resolution failure, the name resolution response creating unit 20 creates a response to the DNS server 1 (S112). In the example illustrated in FIG. 12A, the communication permission port list 16a is searched by using the name A.outside.com serving as the querying destination as a search key, the name resolution failure occurs when there are none of port numbers (that are not hit) enabling the communication.

The response to the name resolution request packet is packetized by the transmitting packet creation unit 12 and transmitted via the communication terminating unit 10 (S111).

The above is the operation of the DNS server 1 at the point G in FIG. 12A in the communication to the global IP address network from the private IP address network at the name-based communication rejection time shown in FIG. 12A. Namely, in the communication from the private IP address network to the global IP address network when the communication is rejected based on the name, the DNS server 1 operates in the sequence such as S100-S101-S104-S105-S106-S107-S108-S112-S111.

According to the invention, in the communication to the global IP address network from the private IP address network, the communication can be rejected by use of the name (e.g., a host name or a domain name) of the terminal serving as the querying destination.

(4) Rejecting communication due to port

Next, the communication (corresponding to (3) in FIG. 5) from within the private IP address network into the global IP address network, which is rejected due to port, will be explained by use of FIGS. 9, 10, 13.

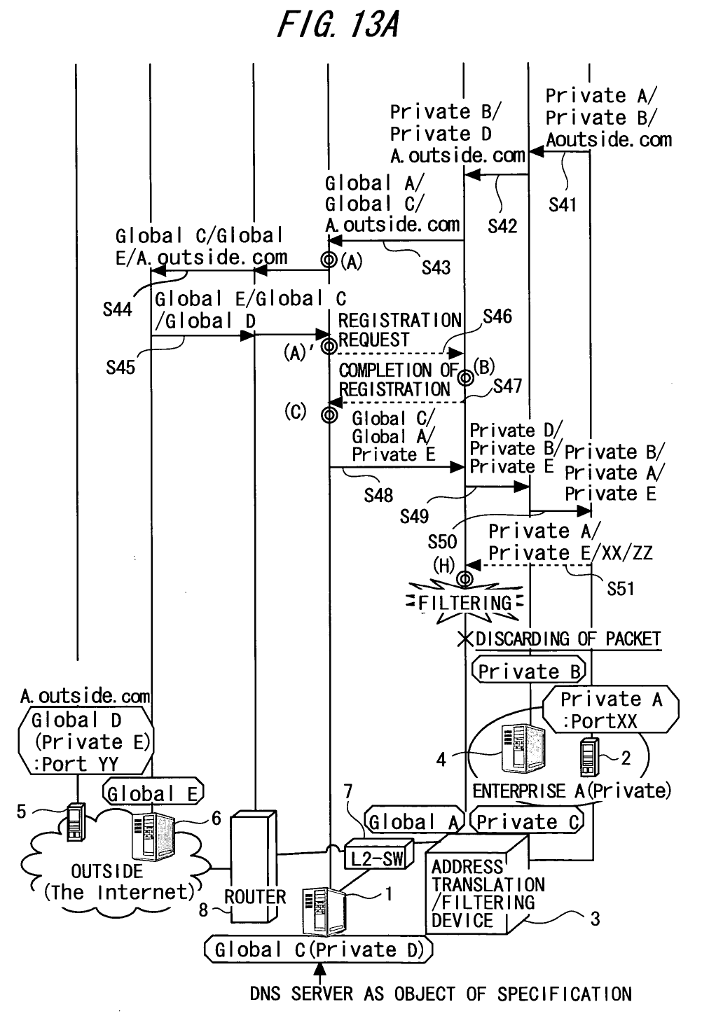

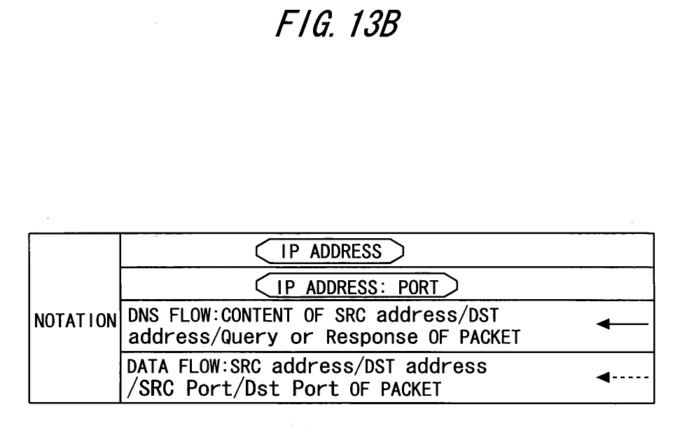

FIG. 13 is a processing sequence showing the communication from within the private IP address network into the global IP address network when rejecting the communication on the basis of the port. Herein, the explanation is made on the assumption of a case of inhibiting the communication to the server 5 having “ZZ” as a port number. Note that FIG. 13 shows a process executed when rejecting the packet in S11 in FIG. 3A, wherein S41 through S50 are the same as Si through S10 in FIG. 3A, and hence their explanations are omitted, but the description starts from S51.

The terminal 2, upon receiving the response packet from the DNS server 4, knows that the response to the query is “Private E”. Namely, the terminal 2 knows that the IP address corresponding to the queried name (A.outside.com) is “Private E”.

The terminal 2, for starting the communication with the server 5, transmits the data packet (S51). In this case, “Private A (source IP address)”, “Private E (destination IP address)”, “XX (source port number)” and “ZZ (destination port number)” are set in the header of the data packet.

The data packet sent from the terminal 2 passes through the address translation/filtering device 3 on the gray zone. At this time, the address translation/filtering device 3 effects filtering based on the destination port number of the data packet, and discards the data packet judged to be impermissible of the communication. In the example shown in FIG. 13, the filtering is effected with respect to the destination port number “ZZ” of the data packet. In the embodiment, the communication to the port number “ZZ” is inhibited, and hence the packet is discarded.

### Operation Flow of Address Translation/Filtering Device 3 at Point H

Next, a process at a point H in FIG. 13 will be explained by use of FIG. 10. S120 and S121 in FIG. 10 are the same as those in the communication from within the private IP address network into the global IP address network at the communication permitting time in FIG. 3A, and the their explanations are omitted, but the description starts from S127.

In S127, the address rewriting/filtering unit 36 searches the address rewriting/filtering database 35. Namely, it searches the database 35 by using the destination IP address of the data packet as a key, and judges whether or not the hit communication permission port number is coincident with the destination port number. In the example shown in FIG. 13, the communication permission port number registered in the database 35 is judged as not being coincident with the destination port number “ZZ” of the data packet, and hence the mis-hit occurs, thereby discarding the packet (S130).

The above is the operation of the address translation/filtering device 3 at the point H in FIG. 13 in the communication to the global IP address network from the private IP address network at the port-based communication rejection time shown in FIG. 13. Namely, in the communication from the private IP address network to the global IP address network when the communication is rejected based on the port, the address translation/filtering device 3 operates in the sequence such as S120-S121-S127-S130.

According to the invention, in the communication to the global IP address network from the private IP address network, on the occasion of the packet passing through address translation/filtering device 3, it can be judged based on the port number of the data packet whether the communication is permitted or not, whereby the whether the packet is allowed to pass through or not can be judged.

[Communication to Private IP Address Network from Global IP Address Network]

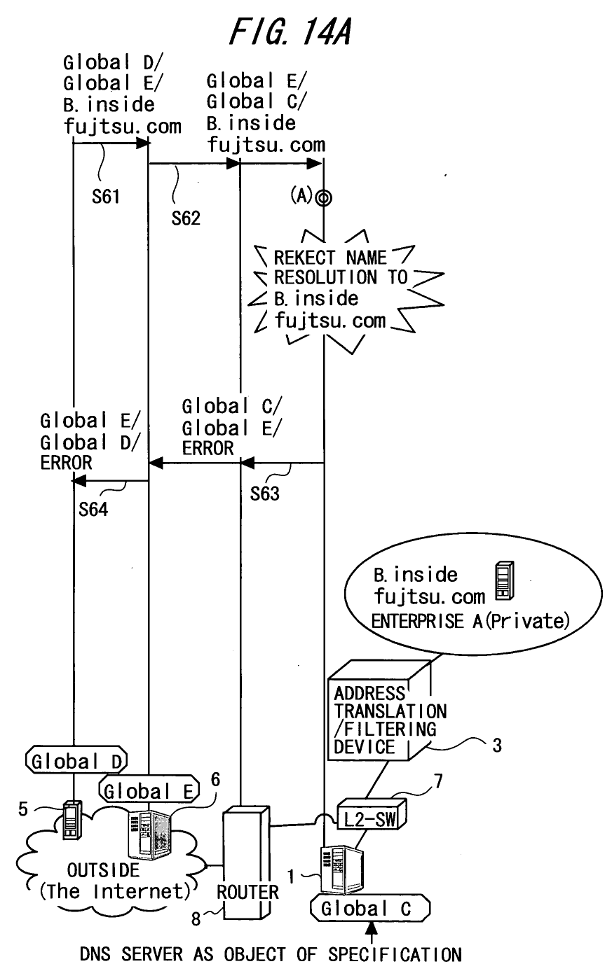

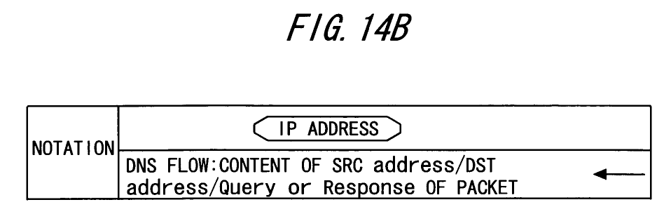

Next, the communication (corresponding to (2) in FIG. 5) to the private IP address network from the global IP address network will be explained by use of FIGS. 14A and 14B.

FIGS. 14A and 14B are a processing sequence showing the communication to the private IP address network from the global IP address network and its notation respectively. In an example shown in FIG. 14A, a name “B.inside.fujitsu.com” is set in the terminal 2.

To begin with, when forwarding the packet to the terminal 2 from the server 5 accommodated in the global IP address network (the network within the Internet, the server 5 sends a name resolution request packet addressed to the DNS server 6 residing in the same network in order to know the IP address of the terminal 2 (S61). In this case, the packet to be sent has “Global D (source address)”, “Global C (destination address)” and “B.inside.fujitsu.com(query: name of the name resolution object terminal 2)”.

Next, the DNS server 6 is unable to solve the name resolution request by the self-possessed zone information and therefore transmits the name resolution request packet in which the DNS server 1 located on the gray zone is set in the destination address (S62). The name resolution request packet at this time contains “Global E (source destination address)”, “Global C (destination address)” and “B.inside.fujitsu.com”.

The DNS server 1 judges, based on the name resolution request packet received from the DNS server 6, whether the communication is permitted or not. In the embodiment, the communication from the global IP address network to the private IP address network is inhibited, and hence the name resolution request given from the global IP address network is rejected. Namely, the DNS server 1 transmits the response packet containing the name resolution failure (ERROR) to the DNS server 6 (S63). In this case, the response packet to be transmitted contains “Global C (source address)”, [Global E (destination address)] and [ERROR (response)].

The DNS server 6, upon receiving the response packet, transmits the response packet to the name resolution request packet to the server 5 (S64). At this time, the response packet contains “Global E (source address)”, “Global D (destination address)” and “ERROR (response)”.

The server 5 receives the response packet from the DNS server 6 and is thereby able to know that the name resolution can not be done for the terminal 2 residing in the private IP address network.

### Operation Flow of DNS Server 1 at Point I

Next, a process at a point I in FIG. 14A will be explained by use of FIG. 9. S100 through S105 in FIG. 9 are the same as those in the communication from the private IP address network to the global IP address network in FIG. 3A. Therefore, the communication from the global IP address network to the private IP address network shown in FIG. 14A will be described starting from S106 in FIG. 9.

In S106, the name resolution unit 15 rejects the name resolution request in a case where the IP address (the source address) indicating the querying source of the name resolution request packet is the address within the global IP address network, and the name of the querying destination of the packet is the name of the server within the private IP address network, i.e., in a case of corresponding to (2) in FIG. 5 (S115).

The above is the operation of the DNS server 1 at the point I in FIG. 14A in the communication to the private IP address network from the global IP address network shown in FIG. 14A. Namely, in the communication from the global IP address network to the private IP address network, the DNS server 1 operates in the sequence such as S100-S101-S104-S105-S106-S115.

According to the invention, the DNS server 1 can inhibit the communication (reject the name resolution) from the global IP address network to the private IP address network, and can function as the normal DNS server.

[Communication from Global IP Address Network to Global IP Address Network]

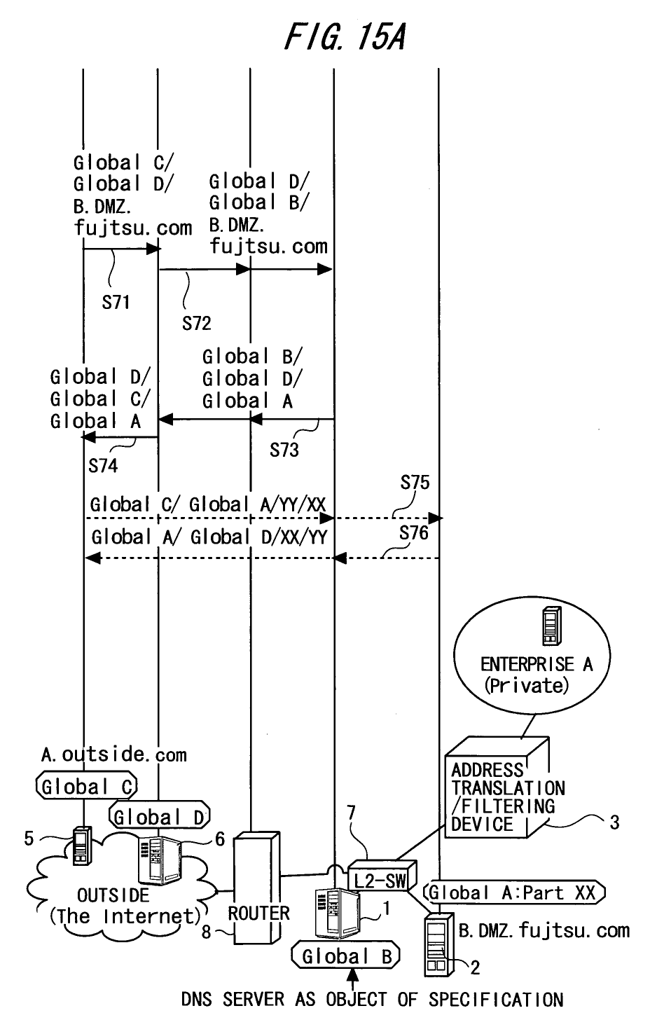

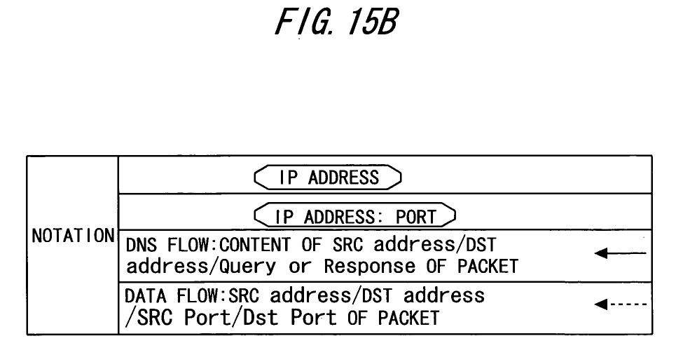

A communication (corresponding to (4) in FIG. 5) from the global IP address network to the global IP address network, will be described by use of FIGS. 15A and 15B.

FIGS. 15A and 15B are a processing sequence showing the communication from the global IP address network to the global IP address network and its notation respectively. In an example shown in FIG. 15A, in the global IP address network, “Global D” is set in the DNS server 6, and “Global C (the global IP address)” and “Port YY (the port number)” are set in the server 5. Further, in the private IP address network, “Global A (the global IP address)”, “Port XX (the port number)” and “Name (B.DMZ.fujitsu.com)” are set in the terminal 2. Moreover, on the gray zone, “Global B” is set in the DNS server 1.

At first, when forwarding the packet to the terminal 2 from the server 5 accommodated in the global IP address network (the network within the Internet), the server 5 sends a name resolution request packet to the DNS server 6 residing in the same network in order to know the IP address of the terminal 2 (S71). In this case, the packet to be sent contains “Global C (source address)”, “Global D (destination address)” and “B.DMZ.fujitsu.com(query: name of the name resolution object terminal 2)”.

Next, the DNS server 6 is unable to solve the name resolution request by the self-possessed zone information and therefore transmits the name resolution request packet in which the DNS server 1 located on the gray zone is set in the destination address (S72). The name resolution request packet at this time contains “Global D (source address)”, “Global B (destination address)” and “B.DMZ.fujitsu.com (query: name of the name resolution object terminal 2)”.

The DNS server 1 receives the name resolution request packet from the DNS server 6. Then, the response packet in which the IP address corresponding to the name contained in the name resolution request packet is the response, is sent back to the DNS server 6 (S73). At this time the response packet contains “Global B (source address)”, “Global D (destination address)” and “Global A (response: the global IP address corresponding to the name)”.

The DNS server 6, upon receiving the response packet, transmits the response packet to the name resolution request to the server 5 (S74). At this time, the packet contains “Global D (source address)”, “Global C (destination address)” and “Global A”.

The server 5 transmitting the name resolution request packet knows that the response to the query is “Global A” from the content s of the response packet received from the DNS server 6. Namely, the server 5 knows that the IP address corresponding to the queried name (B.DMZ.fujitsu.com) is “Global A”.

The server 5 transmits the data packet for starting the communication with the terminal 2 having “Global A” (S75). In this instance, “Global C (source address)”, “Global A (destination address)”, and “YY (source port number)”, and “XX (destination port number)” are set in the header of the data packet.

The terminal 2, upon receiving the data packet from the server 5, sends the data packet back to the server 5 (S76). In this case, “Global A (source address)”, “Global C (destination address)”, and “XX (source port number)”, and “YY (destination port number)” are set in the header of the data packet.

### Operation flow of DNS Server 1

Next, an operation of the DNS server 1 in FIG. 15A will be explained. As for the DNS server 1, the operation in S100 through S105 is the same as that in the communication from the private IP address network to the global IP address network shown in FIG. 3A, and hence its explanation is omitted, and the description is made starting from S106.

In S106, when both of the querying destination and the querying source of the packet are in the global IP address network, i.e., in the case of corresponding to (4) in FIG. 5, the name resolution unit 15 searches the name/address database (global) 15b (S107).

When the IP address is hit as a result of the name resolution unit 15 having searched the name/address database (global) 15b, the response to the querying source is the hit global IP address, and it advances to S112. In S107, when a result of the name resolution unit 15 having searched the name/address database (global) 15b turns out a mis-hit, a name resolution failure occurs, and it advances to S112.

In S112, the name resolution response creating unit 20 creates a DNS response. The created DNS response is packetized by the transmitting packet creation unit 12 and sent onto the network via the communication terminating unit 10 (S111).

According to the invention, the DNS server 1 can function as the normal DNS server residing on the global IP address network for the communication from the global IP address network to the global IP address network.

[Communication from Private IP Address Network to Private IP Address Network]

Next, a communication (corresponding to (1) in FIG. 5) from the private IP address network to the private IP address network, will be explained.

### Operation Flow of DNS Server 1

The communication from the private IP address network to the private IP address network corresponds to (1) in FIG. 5, and hence the operation of the DNS server 1 is the same as that in the communication (corresponding to (4) in FIG. 5) from the global IP address network to the global IP address network in FIG. 15A.

According to the invention, the DNS server 1 can function as the normal DNS server residing on the private IP address network for the communication from the private IP address network to the private IP address network.

According to the invention, it is feasible to actualize the communications extending over the different IP networks by making the DNS server and the address translation device residing on the boundary between the IP networks cooperate with each other without using the proxy server.

1. A name/address translation device comprising:
a judging unit for judging, when receiving a query, transmitted from a communication source, about an address corresponding to a name of a communication destination, whether a communication between the communication source and a communication destination is permitted or not, on the basis of network types to which the communication source and the communication destination respectively belong;
a second judging unit for judging based on a result of the judgment by the judging unit whether or not a communication destination address corresponding to the name is given as a response to the communication source; and
a response unit for acquiring, when the second judging unit judges that the address of the communication destination is given as the response, the address of the communication destination and giving the address of the communication destination as the response to the communication source.

2. A name/address translation device comprising:
a receiving unit for receiving a query about a communication destination address corresponding to a communication destination name, the query being transmitted from a first network and a second network;
an identifying unit for identifying networks to which a communication source having transmitted the query and the communication destination respectively belong;
a searching unit for searching for an address of the communication destination to be given to the communication source as a response when the communication source belongs to the first network and when the communication destination belongs to the second network; and
a sending unit for sending the response containing the address of the communication destination,
wherein the sending unit, when the communication source belongs to the second network and when the communication destination belongs to the first network, does not send the response containing the address of the communication destination.

3. A name/address translation device according to claim 2, wherein the sending unit, when there is no application of which a use is permitted in a communication between the communication source belonging to the first network and the communication destination belonging to the second network, does not give the response of the communication destination address to the communication source.

4. A name/address translation device according to claim 2 or 3, further comprising notifying unit for notifying a routing device of passage information for letting data pass through that are forwarded between a first terminal and a second terminal, the routing device receiving, when a response of an address of the second terminal corresponding to the communication destination belonging to the second network is given to the first terminal corresponding to the communication source belonging to the first network, pieces of data forwarded between the first network and the second network and letting only the data with its passage permitted pass through, and effecting an address translation between the first network and the second network.

5. A name/address translation device according to claim 4, wherein the notifying unit, when the routing device lets the data transmitted from the second terminal pass through, notifies the routing device of passage information containing an address of the first network that is virtually assigned to the second terminal and an on-the-second-network address of the second terminal in order to translate the on-the-second-network address of the second terminal that is added as a source address to this piece of data into an on-the-first network address, and
the sending unit, when the first terminal adds the on-the-first-network address of the second terminal to the data addressed to the second terminal and thus transmits it and when the routing device lets the data addressed to the second terminal pass through, sends a response containing the one-the-first-network address of the second terminal in order to translate the destination address added to this piece of data into the on-the-second-network address of the second terminal.

6. A name/address translation device according to claim 4 or 5, wherein the notifying unit notifies the routing device of the passage information further containing information about an application of which the utilization is permitted in the communication between the first terminal and the second terminal in order for the routing device to let only the data pass through which is based on the application of which the utilization is permitted between the first terminal and the second terminal.

7. A name/address translation device according to any one of claims 4-6, wherein the notifying unit notifies, before the sending unit sends the address of the second terminal, the routing device of the passage information.

8. A name/address translation method making a computer functioning as a name/address translation device, execute:
a judging step of judging, when receiving a query, transmitted from a communication source, about an address corresponding to a name of a communication destination, whether a communication between a communication source and a communication destination is permitted or not, on the basis of network types to which the communication source and the communication destination respectively belong;
a second judging step of judging based on a result of the judgment in the judging step whether or not a communication destination address corresponding to the name is given as a response to the communication source; and
a response step of acquiring, when it is judged in the second judging step that the address of the communication destination is given as the response, the address of the communication destination and giving the address of the communication destination as the response to the communication source.

9. A name/address translation method making a computer functioning as a name/translation device, execute:
a receiving step of receiving a query about a communication destination address corresponding to a communication destination name, the query being transmitted from a first network and a second network;
an identifying step of identifying networks to which a communication source having transmitted the query and the communication destination respectively belong;
a searching step of searching for an address of the communication destination to be given to the communication source as a response when the communication source belongs to the first network and when the communication destination belongs to the second network; and
a sending step of sending the response containing the address of the communication destination,
wherein when the communication source belongs to the second network and when the communication destination belongs to the first network, the response containing the address of the communication destination is not sent.

10. A name/address translation method according to claim 9, wherein the computer, when there is no application of which a use is permitted in a communication between the communication source belonging to the first network and the communication destination belonging to the second network, does not give the response of the communication destination address to the communication source.

11. A name/address translation method according to claim 9 or 10, wherein the computer further executes a notifying step of notifying a routing device of passage information for letting data pass through that are forwarded between a first terminal and a second terminal, the routing device receiving, when a response of an address of the second terminal corresponding to the communication destination belonging to the second network is given to the first terminal corresponding to the communication source belonging to the first network, pieces of data forwarded between the first network and the second network and letting only the data with its passage permitted pass through, and effecting an address translation between the first network and the second network.

12. A name/address translation method according to claim 11, wherein the computer, when the routing device lets the data transmitted from the second terminal pass through, notifies the routing device of passage information containing an address of the first network that is virtually assigned to the second terminal and an on-the-second-network address of the second terminal in order to translate the on-the-second-network address of the second terminal that is added as a source address to this piece of data into an on-the-first network address, and
the computer, when the first terminal adds the on-the-first-network address of the second terminal to the data addressed to the second terminal and thus transmits it and when the routing device lets the data addressed to the second terminal pass through, sends a response containing the one-the-first-network address of the second terminal in order to translate the destination address added to this piece of data into the on-the-second-network address of the second terminal.

13. A name/address translation method according to claim 11 or 12, wherein the computer notifies the routing device of the passage information further containing information about an application of which the utilization is permitted in the communication between the first terminal and the second terminal in order for the routing device to let only the data pass through which is based on the application of which the utilization is permitted between the first terminal and the second terminal.

14. A name/address translation method according to any one of claims 11-13, wherein the computer notifies, before sending the address of the second terminal, the routing device of the passage information.

15. A program making a computer function as a name/address translation device or a recording medium recorded with this program, making the computer execute:
a judging step of judging, when receiving a query, transmitted from a communication source, about an address corresponding to a name of a communication destination, whether a communication between a communication source and a communication destination is permitted or not, on the basis of network types to which the communication source and the communication destination respectively belong;
a second judging step of judging based on a result of the judgment in the judging step whether or not a communication destination address corresponding to the name is given as a response to the communication source; and
a response step of acquiring, when it is judged in the second judging step that the address of the communication destination is given as the response, the address of the communication destination and giving the address of the communication destination as the response to the communication source.

16. A program making a computer function as a name/address translation device or a recording medium recorded with this program, making the computer execute:
a receiving step of receiving a query about a communication destination address corresponding to a communication destination name, the query being transmitted from a first network and a second network;
an identifying step of identifying networks to which a communication source having transmitted the query and the communication destination respectively belong;
a searching step of searching for an address of the communication destination to be given to the communication source as a response when the communication source belongs to the first network and when the communication destination belongs to the second network; and
a sending step of sending the response containing the address of the communication destination,
wherein when the communication source belongs to the second network and when the communication destination belongs to the first network, a step of not sending the response containing the address of the communication destination is executed.

17. A program or a recording medium recorded with this program according to claim 16, wherein the computer, when there is no application of which a use is permitted in a communication between the communication source belonging to the first network and the communication destination belonging to the second network, executes a step of judging that the response of the communication destination address is not given to the communication source.

18. A program or a recording medium recorded with this program according to claim 16 or 17, wherein the computer further executes a notifying step of notifying a routing device of passage information for letting data pass through that are forwarded between a first terminal and a second terminal, the routing device receiving, when a response of an address of the second terminal corresponding to the communication destination belonging to the second network is given to the first terminal corresponding to the communication source belonging to the first network, pieces of data forwarded between the first network and the second network and letting only the data with its passage permitted pass through, and effecting an address translation between the first network and the second network.

19. A program or a recording medium recorded with this program according to claim 18, wherein the computer, when the routing device lets the data transmitted from the second terminal pass through, executes:
a step of notifying the routing device of passage information containing an address of the first network that is virtually assigned to the second terminal and an on-the-second-network address of the second terminal in order to translate the on-the-second-network address of the second terminal that is added as a source address to this piece of data into an on-the-first network address, and
a step of, when the first terminal adds the on-the-first-network address of the second terminal to the data addressed to the second terminal and thus transmits it and when the routing device lets the data addressed to the second terminal pass through, sending a response containing the one-the-first-network address of the second terminal in order to translate the destination address added to this piece of data into the on-the-second-network address of the second terminal.

20. A program or a recording medium recorded with this program according to claim 18 or 19, wherein the computer executes a step of notifying the routing device of the passage information further containing information about an application of which the utilization is permitted in the communication between the first terminal and the second terminal in order for the routing device to let only the data pass through which is based on the application of which the utilization is permitted between the first terminal and the second terminal.

21. A program or a recording medium recorded with this program according to any one of claims 18-20, wherein the computer executes a step of notifying, before sending the address of the second terminal in the sending step, the routing device of the passage information.
